(19) United States
(12) Patent Application Publication
(10) Pub. No.: US 2014/0156468 A1
(43) Pub. Date: Jun. 5, 2014

(54) PRINT ORDER RECEIVING AND PLACING SYSTEM AND METHOD FOR CONTROLLING THE SAME

(71) Applicant: CANON KABUSHIKI KAISHA, Tokyo (JP)

(72) Inventor: Kei Tamagawa, Tokyo (JP)

(73) Assignee: CANON KABUSHIKI KAISHA, Tokyo (JP)

(21) Appl. No.: 14/091,068

(22) Filed: Nov. 26, 2013

(30) Foreign Application Priority Data
Nov. 30, 2012 (JP) 2012-263128

(51) Int. Cl. G06Q 30/06

(52) U.S. Cl. CPC G06Q 30/0635
USPC 705/26.81

(57) ABSTRACT

A print order receiving and placing system capable of reducing workloads on operator's ordering operations and input errors. The system for receiving a print product production request from an order placing terminal includes a print process registration unit configured to register a print process including setting information about printing by a printing machine, a processing process registration unit configured to register a processing process including setting information about processing by a processing machine, a product registration unit configured to register a product including a product specification for defining a print process selected from a plurality of registered print processes, a processing process selected from a plurality of registered processing processes, and order information regarding an execution order of these processes, and an item registration unit configured to register the registered product as an item which can be ordered from the order placing terminal.

### BACKGROUND OF THE INVENTION

1. Field of the Invention

The present invention relates to a print order receiving and placing system for receiving a print product production request from a purchaser.

2. Description of the Related Art

Conventionally, when a printing company receives a print order from a purchaser, an operator of the printing company prepares, as a pre-print preparation process, operation instructions which describes operation procedures for producing a print product based on a print specification for the print product described in an order sheet, such as a paper type, a paper size, and a binding method. Then, the operator sets setting items for printing print data according to a specified print specification, in a specific folder called HotFolder. Then, as a print process, the operator enters the print data in relevant HotFolder to print the target print product (see Japanese Laid-Open Patent Application No. 2005-135174).

However, in the above-described pre-print preparation process, even in a case of a print product which can be produced from one product specification, the operator needs to input the print specification to the system to prepare operation instructions for each print product. For example, suppose a case where the printing company has already produced a product catalog for company A finished with coated paper type, A4 paper size, and perfect binding, and receives an order for a product catalog for company B finished with only a different paper type. In this case, the paper type differs between the product catalog for company A and the product catalog for company B. Therefore, the operator of the printing company had to enter a new print specification as a different print product, and register the print product in the system. Accordingly, even with a print product having a similar print specification, the operator had to input a print specification in the system from the beginning, resulting in high workloads on operator's input operations and high probability that an operator's input error occurs.

In recent years, a Web-to-Print service for receiving a print order via the Internet has reduced barrier of order placing, increasing the number of orders from ordinary individuals. Orders from ordinary individuals are characterized in that a large number of orders for a small number of products in conventional cases have shifted to a small number of orders for a large number of products. Thus, since the ratio of the time duration for input operations to the total operation time related to one order has increased, reducing the time duration for input operations has become a still more important for the printing company to improve the productivity.

### SUMMARY OF THE INVENTION

The present invention is directed to a print order receiving and placing system and a method for controlling the system capable of reducing workloads on operator's ordering operations and reducing operator's input errors.

According to an aspect of the present invention, a print order receiving and placing system for receiving a print product production request from an order placing terminal includes a print process registration unit configured to register a print process including setting information related to printing by a printing machine, a processing process registration unit configured to register a processing process including setting information related to processing by a processing machine, a product registration unit configured to register a product including a product specification defining a print process selected from a plurality of print processes registered by the print process registration unit, a processing process selected from a plurality of processing processes registered by the processing process registration unit, and order information regarding an execution order of these processes, and an item registration unit configured to register the product registered by the product registration unit, as an item which can be ordered from the order placing terminal.

According to the present invention, it becomes possible to provide a print order receiving and placing system and a method for controlling the system capable of reducing workloads on operator's ordering operations and reducing operator's input errors.

Further features and aspects of the present invention will become apparent from the following detailed description of exemplary embodiments with reference to the attached drawings.

### BRIEF DESCRIPTION OF THE DRAWINGS

FIG. 1 is a block diagram illustrating a hardware configuration of a print order receiving and placing system according to an exemplary embodiment of the present invention.

FIG. 2 is a block diagram illustrating a hardware configuration of a computer and a server according to an exemplary embodiment of the present invention.

FIG. 3 is a block diagram illustrating a logical configuration of a print order receiving and placing system according to a first exemplary embodiment.

FIG. 4 is a flowchart illustrating an example of processing from initial setting to print product shipment according to the first exemplary embodiment.

FIGS. 5A and 5B are sequence charts respectively illustrating an example of processing for initial setting and item registration according to the first exemplary embodiment.

FIG. 6 illustrates an example of a paper registration screen according to the first exemplary embodiment.

FIG. 7 illustrates an example of a menu screen according to the first exemplary embodiment.

FIG. 8 illustrates an example of a device registration screen according to the first exemplary embodiment.

FIG. 9 illustrates an example of a setting item appending screen according to the first exemplary embodiment.

FIG. 10 illustrates an example of a ticket generation screen according to the first exemplary embodiment.

FIG. 11 illustrates an example of a print job ticket registration screen according to the first exemplary embodiment.

FIG. 12 illustrates an example of a print setting registration screen according to the first exemplary embodiment.

FIG. 13 illustrates an example of a print process registration screen according to the first exemplary embodiment.

FIG. 14 illustrates an example of a processing process registration screen according to the first exemplary embodiment.

FIG. 15 illustrates an example of a product specification registration screen according to the first exemplary embodiment.

FIG. 16 (consisting of 16A and 16B) is a flowchart (1/2) illustrating an example of processing for registering a product specification in the product specification registration screen according to the first exemplary embodiment.

FIG. 17 is a flowchart (2/2) illustrating an example of processing for registering a product specification in the product specification registration screen according to the first exemplary embodiment.

FIG. 18 is a flowchart illustrating an example of processing for searching for a product specification in the product specification search screen according to the first exemplary embodiment.

FIG. 19 illustrates an example of a print process search screen according to the first exemplary embodiment.

FIG. 20 illustrates an example of a preliminary fee calculation screen according to the first exemplary embodiment.

FIG. 21 is a flowchart illustrating an example of processing for preliminarily calculating a printing fee in the preliminary fee calculation screen according to the first exemplary embodiment.

FIG. 22 illustrates an example of a product registration screen according to the first exemplary embodiment.

FIG. 23 illustrates an example of an item registration screen according to the first exemplary embodiment.

FIG. 24 is a flowchart illustrating an example of processing for placing an order in a purchaser environment according to the first exemplary embodiment.

FIG. 25 illustrates an example of an item list screen according to the first exemplary embodiment.

FIG. 26 illustrates an example of an order history screen according to the first exemplary embodiment.

FIG. 27 illustrates an example of an order list screen according to the first exemplary embodiment.

FIG. 28 illustrates an example of a detailed order screen according to the first exemplary embodiment.

FIG. 29 is a flowchart illustrating an example of processing in the detailed order screen according to the first exemplary embodiment.

FIG. 30 is a block diagram illustrating a logical configuration of a print order receiving and placing system according to a second exemplary embodiment.

FIG. 31 is a flowchart illustrating an example of processing ranging from initial setting to print product shipment according to the second exemplary embodiment.

FIGS. 32A and 32B are sequence charts illustrating an example of processing for initial setting and item registration according to the second exemplary embodiment.

FIG. 33 illustrates an example of a design editing screen according to the second exemplary embodiment.

### DESCRIPTION OF THE EMBODIMENTS

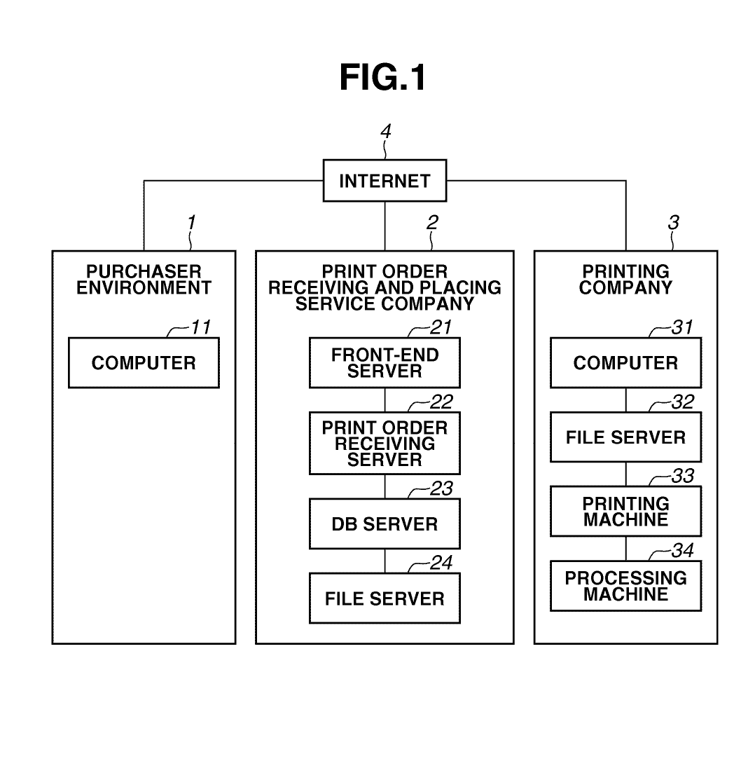

A first exemplary embodiment of the present invention will be described below. A hardware configuration of a print order receiving and placing system according to the present exemplary embodiment will be described below with reference to FIG. 1.

### <Hardware Configuration of Print Order Receiving and Placing System>

Referring to FIG. 1, a purchaser environment 1 is an environment of a purchaser who is a customer placing an order for a print product of the present print order receiving and placing system. A print order receiving and placing service company 2 manages the print order receiving and placing system. A printing company 3 receives a print order from the purchaser by using the print order receiving and placing system, produces a print product, and sends the print product to the purchaser. The purchaser environment 1, the print order receiving and placing service company 2, and the printing company 3 are connected to the Internet 4. A computer (order placing terminal) 11 is used by the purchaser to place a print order. A front-end server 21 authenticates a purchaser, presents a list of print products for which the purchaser can place an order, and responds to a request from the purchaser to accept an order from the purchaser. A print order receiving server 22 manages printing information, and responds to a request on the printing information from the front-end server 21 and the printing company 3. A database server 23 stores printing information. A file server 24 stores printing-related files. A computer 31 is used by an operator of the printing company 3 to acquire and transmit information about a print order, and control a printing machine and a processing machine. A file server 32 stores printing-related files managed by the printing company 3. A printing machine 33 is used by the printing company 3 to print products. A processing machine 34 is used by the printing company 3 to process print products.

### <Hardware Configuration of Computers and Servers>

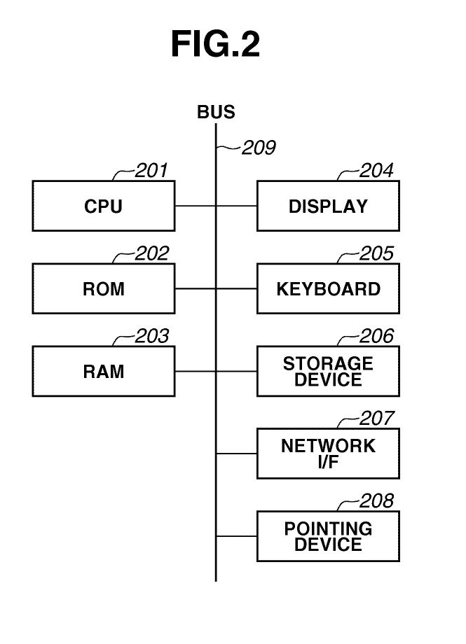

The following describes a hardware configuration of the above-described computers and servers, with reference to FIG. 2. Referring to FIG. 2, a central processing unit (CPU) 201 reads, interprets, and executes a computer program stored in a storage device 206 (described below). Then, the CPU 201 controls a random access memory (RAM) 203 and a display 204 (described below) connected via a bus 209 (described below). A read-only memory (ROM) 202 performs low-level input/output control with the hardware connected to the bus 209. The RAM 203 temporarily stores information to be used when the CPU 201 performs calculation. The display 204 displays the result of the calculation performed by the CPU 201. A keyboard 205 receives an input (instruction) from a user. The storage device 206 stores programs and data to be used for calculations. A network interface (I/F) 207 connects the system to a local area network, an intranet, or the Internet. A pointing device 208, such as a mouse and a trackball, receives coordinates specified on a screen by the user. The bus 209 is a set of signal lines to which the above-described CPU 201 through the pointing device 208 is connected. The computers and servers are not a major requirement of the present invention, and detailed description thereof will be omitted.

### <Logical Configuration of Print Order Receiving and Placing System>

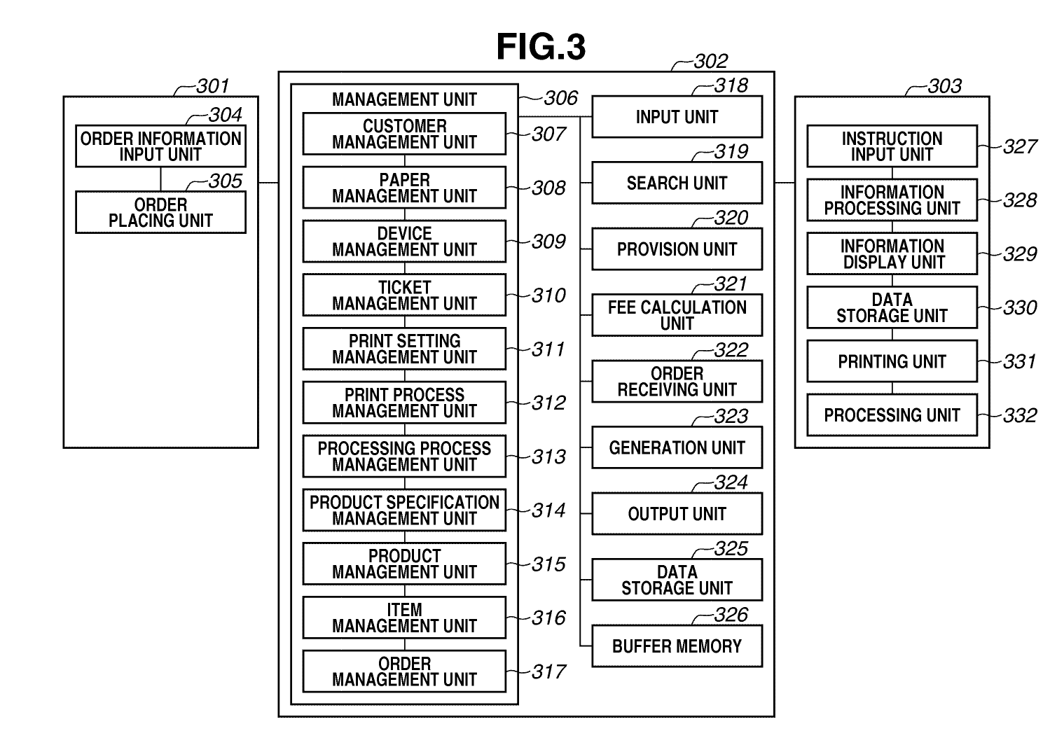

The following describes a logical configuration of the print order receiving and placing system according to the present exemplary embodiment, with reference to FIG. 3.

Referring to FIG. 3, a program 301 operates on the computer 11 of the purchaser environment 1. A program 302 operates on various servers of the print order receiving and placing service company 2. A program 303 operates on the computer 31 of the printing company 3. An order information input unit 304 receives a print order from the purchaser. An order placing unit 305 issues a production request to the print order receiving and placing system, i.e., places an order with the print order receiving and placing system, based on order information received by the order information input unit 304. The management unit 306 includes a customer management unit 307, a paper management unit 308, a device management unit 309, a ticket management unit 310, a print setting management unit 311, a print processes management unit 312, a processing process management unit 313, a product specification management unit 314, a product management unit 315, an item management unit 316, and an order management unit 317. The management unit 306 manages order and printing information, such as customer information, paper information, device information, print settings, print processes, processing processes, product specifications, products, and items. The management unit 306 manages further information, such as a print job ticket template, a print ticket template, a processing job ticket template, and order information. The print job ticket template is a prototype file describing operations for producing a print product and specifications of the print product. The print ticket template is a prototype file describing settings which should be set in a printing machine to print a target print product. The processing job ticket template is a prototype file describing settings which should be set in a processing machine to perform target processing. The customer management unit 307 manages information about a customer who utilizes the print order receiving and placing system, such as an identifier (ID) and a password, and performs customer authentication based on the ID and the password. The paper management unit 308 manages information about paper managed by the printing company 3, such as a name, an ID, a paper size, a paper quality, a paper color, a reference unit price, a manufacturer name, a paper thickness, a grain direction, a ream weight, and a grammage. The grain direction refers to the paper fiber orientation, such as vertical direction or horizontal direction. The ream weight refers to the weight per 1000 sheets of paper finished in predetermined size. The grammage refers to the weight of paper per square meter (g/m²). The device management unit 309 manages information about a device to be used for printing (a printing machine and a processing machine managed by the printing company 3), such as a name, an ID, a manufacturer, whether the relevant device is a digital printing machine, and applicable ticket formats. The device management unit 309 manages further information about the relevant device, such as a print side (one-sided printing or two-sided printing), a paper orientation at the time of printing, a print color, a finishing size, and applicable paper. The ticket management unit 310 manages a ticket to be used for printing, such as a print job ticket template, a print ticket, and a processing job ticket template. The print setting management unit 311 manages information about a print setting to be used to print a print product, such as a finishing size, a bookbinding method, a print side, a paper orientation, a print color, a paper tray to be selected when printing, and a size of paper to be set on the paper tray. The print process management unit 312 manages information about a print process, such as the name of a printing machine to be used for printing, whether the printing machine supports a print job ticket, a use-of-subcontractor flag (indicating whether a subcontractor is to be used), and a print job ticket name (when the printing machine supports the print job ticket). The print process management unit 312 manages further information about the relevant print process, such as the number of components (parts forming the relevant print product, such as paper) constituting the relevant print process, and names and sizes of the components. The processing process management unit 313 manages information about a processing process, such as a name, an ID, a processing class, a use-of-subcontractor flag (indicating whether a subcontractor is to be used), a processing finishing size, and a processing standard unit price. The product specification management unit 314 manages information about a product specification, such as a name, an ID, a category (flier, booklet, catalog, etc.) of the relevant product specification, a use-of-subcontractor flag (indicating whether a subcontractor is to be used), whether the use of the relevant product specification is enabled on the print order receiving and placing system, a reference unit price, and a print process and a processing process constituting the relevant product specification. A product specification may include either a print process or a processing process. For example, in the case of a one-sheet flier not involving processing, the product specification includes only a print process. The product management unit 315 manages information about a product, such as a name, an ID, and a product specification constituting the relevant product. The item management unit 316 manages information about an item, such as a name, an ID, an opening destination front-end service (FES), a price, a date of sales opening, a date of sales end, the number of days till shipment, a maximum number of orderable volumes, and a product constituting the relevant item. The order management unit 317 manages information about an order placed by the purchaser, such as a name, an ID, a date of order placement, a price, and items and print data related to the relevant order. An input unit 318 receives data input from the printing company 3 which utilizes the print order receiving and placing system. A search unit 319 searches for target information from the printing information, such as paper information, device information, and product specifications, stored in a data storage unit 325 (described below). A provision unit 320 arranges a print process and a processing process constituting the product specification in process order, connects related processes, and processes and provides information so that the operator of the printing company 3 can visually confirm the configuration of the relevant product specification via an information display unit 329. A fee calculation unit 321 calculates a printing fee based on a product specification and order information, such as the number of volumes. An order receiving unit 322 receives an order from the purchaser. A generation unit 323 generates information about a method for producing a print product, such as operation instructions, a print ticket, and a job ticket, based on the order received by the order receiving unit 322 and various information managed by the management unit 306. An output unit 324 outputs the information generated by the generation unit 323 according to a request from the printing company 3. A data storage unit 325 stores various information about a customer, paper, a device, a ticket, a print setting, a print process, a processing process, a product specification, a product, an item, an order, and print data to be used by the management unit 306. A buffer memory 326 temporarily stores values in the middle of calculation. An instruction input unit 327 receives an input (instruction) from the operator of the printing company 3. An information processing unit 328 exchanges information with the print order receiving and placing system, a printing machine, or a processing machine, and processes the information according to the input from the instruction input unit 327. The information display unit 329 displays on a display apparatus the information processed by the information processing unit 328. A data storage unit 330 temporarily stores data to be used for printing, such as a print job ticket and print data. A printing unit 331 prints with a printing machine the print data specified by the information processing unit 328. A processing unit 332 processes the component specified by the information processing unit 328.

### <Overall Processing Flow of Printing>

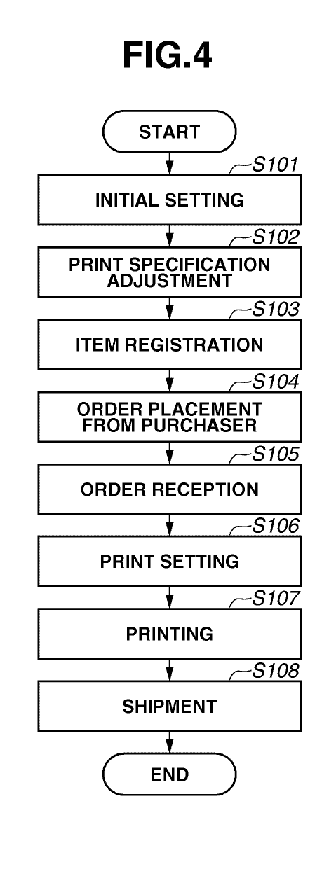

The following describes an overview of an overall operation flow ranging from initial setting for printing to shipment of a print product, with reference to FIG. 4. In step S101, the operator of the printing company 3 registers in the print order receiving and placing system the information about the paper and device to be used for printing, and the print product. In step S102, the purchaser and the printing company 3 perform adjustment of the print specification of the print product. The adjustment may be performed through other than the print order receiving and placing system, i.e., by meeting, telephone, facsimile, or e-mail, or through a method for determining a print specification between the purchaser and the printing company 3 provided in the print order receiving and placing system. Further, the method for determining a print specification may be any method as long as it enables determining a print specification. In step S103, the operator of the printing company 3 registers items of the print specification determined in step S102 in the print order receiving and placing system. In step S104, the purchaser accesses the print order receiving and placing system by using the computer 11 of the purchaser environment 1, and places an order for the items registered in step S103. In step S105, the print order receiving and placing system accepts an order from the purchaser, and notifies the printing company 3 of the order reception. In step S106, the operator of the printing company 3 acquires information for producing a print product corresponding to the order from the print order receiving and placing system, and performs setting for the printing machine and the processing machine. In step S107, the operator of the printing company 3 enters print data in the printing machine, and prints and processes a print product. In step S108, the operator of the printing company 3 sends the printed and processed print product to the purchaser. In this way, the ordered print product is delivered to the purchaser.

<Processing Flow Ranging from Initial Setting to Item Registration>

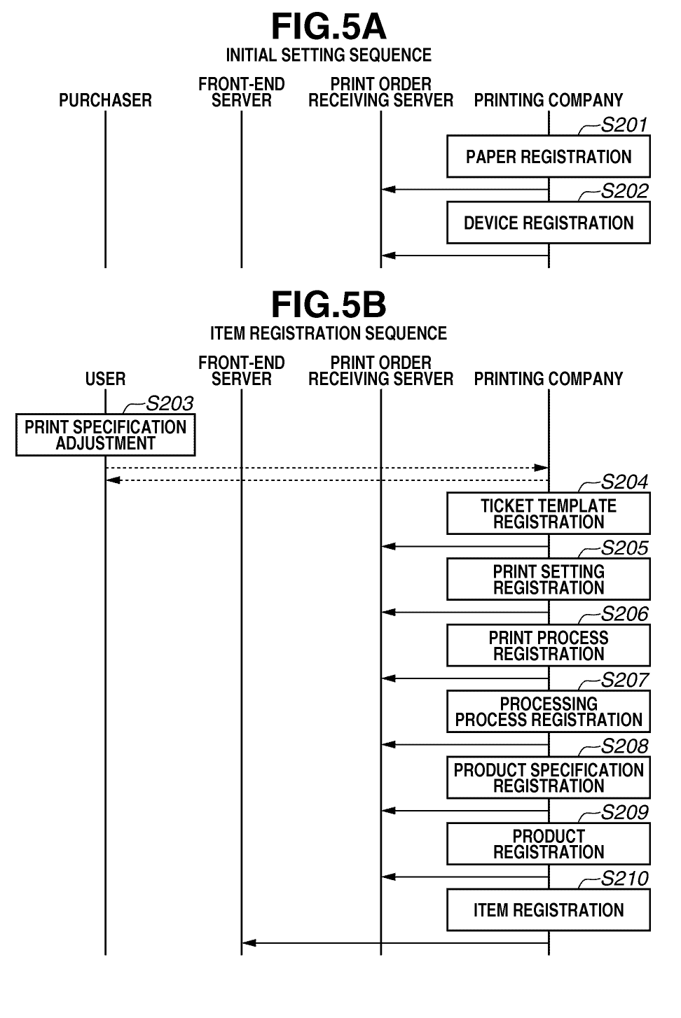

The following describes an operation flow from step S101 to step S103, with reference to FIGS. 5A and 5B. FIG. 5A illustrates an initial setting sequence.

### <Registering Paper>

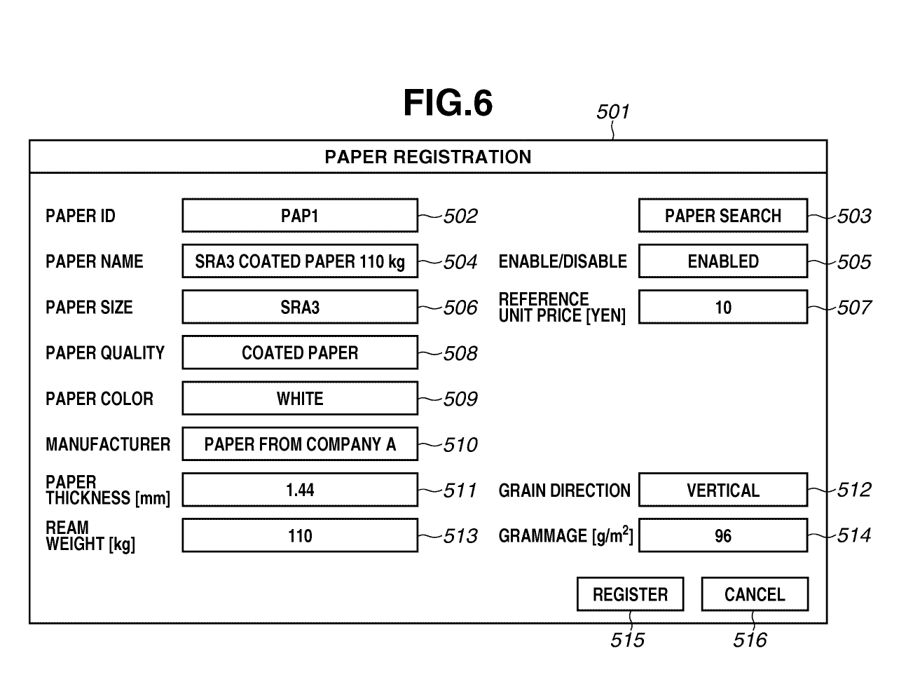

In step S201, the paper management unit 308 receives paper information input to a paper registration screen, as illustrated in FIG. 6, displayed on the information display unit 329, and stores the paper information in the data storage unit 325.

As an example of a paper registration screen, FIG. 6 illustrates a paper register screen 501 for registering in the print order receiving and placing system the paper information displayed on the information display unit 329. The paper register screen 501 is displayed from a menu screen (described below). A paper ID 502 identifies paper. A paper search button 503 searches for paper pre-registered in the print order receiving and placing system. A sheet name 504 indicates the name of paper. An enable/disable flag 505 indicates whether the use of the relevant paper is enabled on the print order receiving and placing system. A paper size 506 indicates the paper size. A reference unit price 507 indicates the unit price of the relevant paper in the size input in the paper size 506. The paper register screen 501 also displays a paper quality 508, a paper color 509, a manufacturer 510, a paper thickness 511, a grain direction 512, a ream weight 513, and a grammage 514. A registration button 515 accepts an operator's instruction for registering the relevant paper with the above-described input setting items, and registers the current setting items in the data storage unit 325. A cancel button 516 accepts an operator's instruction for canceling the paper registration.

When the paper search button 503 has been pressed, the paper management unit 308 displays a paper search screen (not illustrated) on the information display unit 329. The paper search screen includes entry fields for inputting narrow-down conditions, such as a sheet name and a paper size, and a search button for searching for paper which satisfies the narrow-down conditions input in the entry fields. Upon reception of the depression of the search button from the operator, the paper search screen delivers the input narrow-down conditions to the search unit 319. Based on the narrow-down conditions, the search unit 319 searches for paper information stored in the data storage unit 325, and returns the result of the search to the paper management unit 308. The paper management unit 308 displays the received search result on the information display unit 329 via the information processing unit 328. As the search result, paper information is displayed in list form. When the operator selects target paper, information about the selected paper is reflected to respective setting items in the paper register screen 501. The operator can edit and register a target input item. Providing the above-described mechanism allows the operator to register new paper without inputting information about the relevant paper from the beginning.

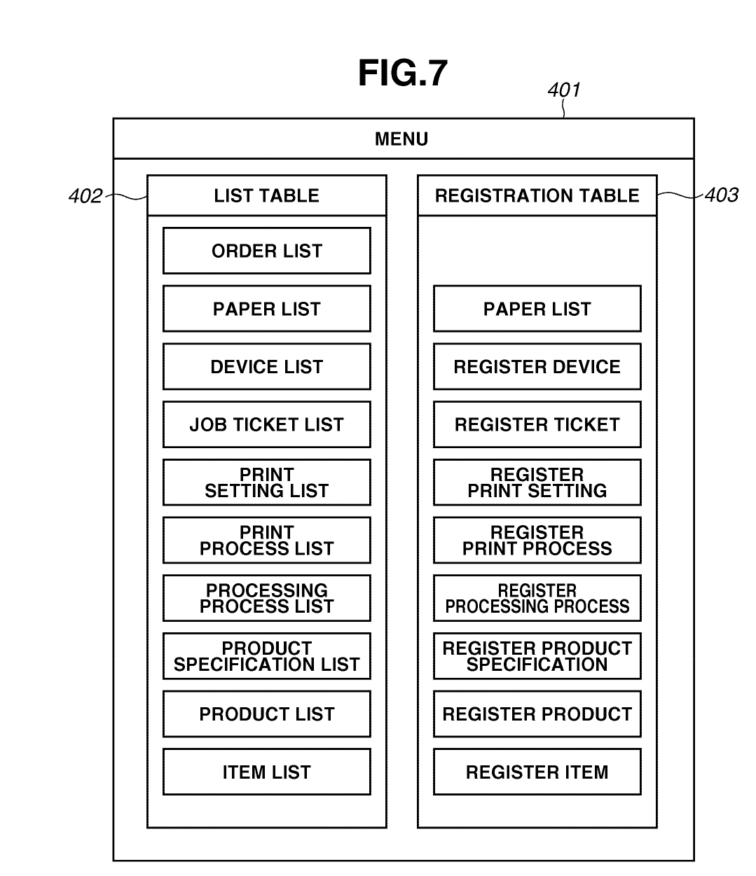

The paper register screen 501 is displayed on the information display unit 329 shifted from the menu screen illustrated in FIG. 7. More specifically, when the operator instructs the program 303 to access the print order receiving and placing system via the instruction input unit 327, the information processing unit 328 requests the print order receiving and placing system to transmit the menu screen. Upon reception of the relevant request, the print order receiving and placing system generates data for displaying the menu screen composed of a script and images, and transmits the relevant data to the information processing unit 328. Upon reception of the relevant data, the information processing unit 328 interprets the relevant script, and displays the menu screen on the information display unit 329. When the operator presses the paper registration button in the menu screen, information indicating that the paper registration button has been pressed is transmitted to the print order receiving and placing system. Upon reception of the relevant information, the print order receiving and placing system generates data for displaying the paper register screen 501, and transmits the relevant data to the information processing unit 328. Upon reception of the relevant data, the information processing unit 328 interprets the relevant data, and displays the paper register screen 501 on the information display unit 329. The paper register screen 501 is displayed on an operator's display through the above-described steps. A well-known technique is used for information exchange (request and response) processing between a client (the computer 31 of the printing company 3 and the computer 11 of the purchaser) and a server. This technique is not a major requirement of the present invention, and detailed description thereof will be omitted.

The following describes a menu screen illustrated in FIG. 7. FIG. 7 illustrates a menu screen 401 which is displayed on the information display unit 329. The menu screen 401 is used by the operator to request the print order receiving and placing system to transmit an order list screen (described below) and a list screen of various information pre-registered in the print order receiving and placing system. FIG. 7 illustrates a menu screen 401 which includes list table 402 and a registration table 403. The list table 402, including an order list button and a paper list button, is used to request the print order receiving and placing system for the acquisition of a list of various information pre-registered in the print order receiving and placing system. The registration table 403, including the paper registration button and a device registration button, is used to display various registration screens for registering various information in the print order receiving and placing system. When displaying the menu screen 401 on the information display unit 329, the operator may display only the menu screen 401 or display an order list screen (described below) together with the menu screen 401, i.e., the operator may display the screens in any desired way to improve operator's working efficiency.

### <Registering a Device>

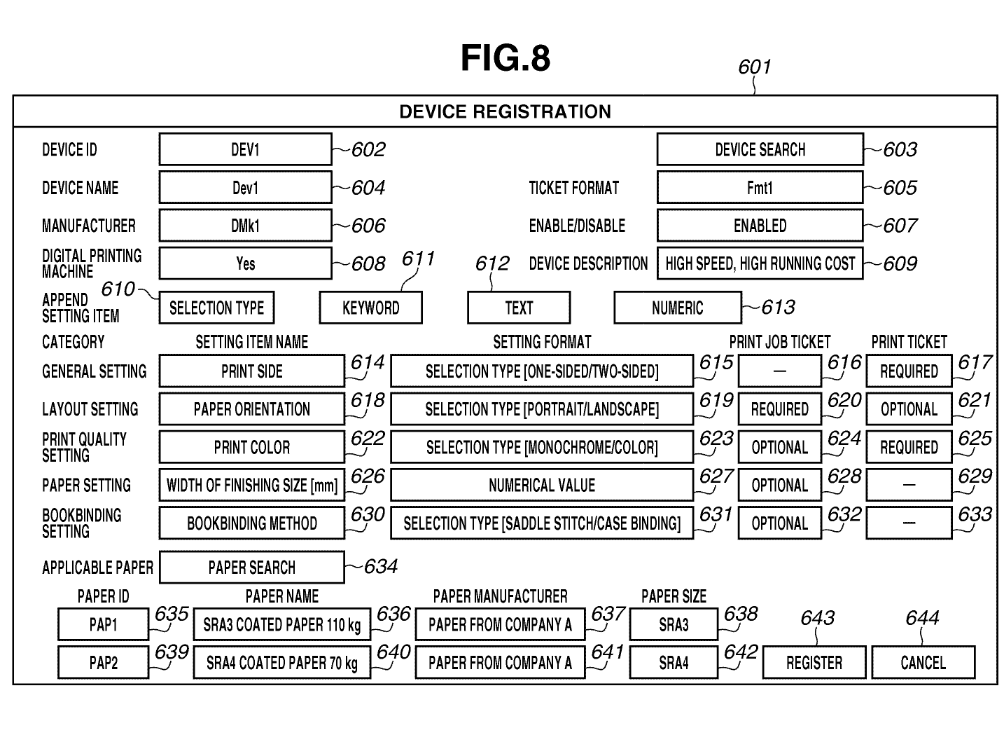

In step S202, the device management unit 309 receives device information input to a device registration screen illustrated in FIG. 8 displayed on the information display unit 329, and stores the device information in the data storage unit 325.

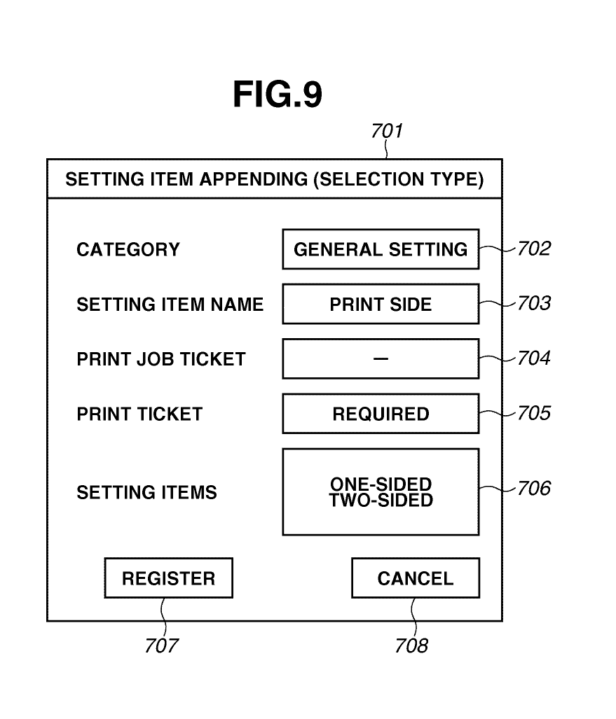

FIG. 8 illustrates a device registration screen 601 for registering information about a device to be managed by the printing company 3. A device ID 602 identifies the relevant device. A device search button 603 calls a device search screen (not illustrated) for searching for a device pre-registered in the print order receiving and placing system. Setting items 604 to 609 include a device name 604, a ticket format 605 for a print job ticket applicable to the relevant device, a device manufacturer name 606, an enable/disable flag 607 (indicating whether the use of the relevant device is enabled on the print order receiving and placing system), a printing machine class 608 (indicating whether the relevant device is a digital printing machine), and a device description 609 providing supplemental information about the relevant device. A selection type button 610, a keyword button 611, a text button 612, and a numeric button 613 are used to append a setting item related to the relevant device in respective formats (described in detail below with reference to FIG. 9). Entry fields 614 to 629 are used to register setting items to be appended to a print job ticket and a print ticket when the relevant device is to be used. Setting items 614 to 617 enable selecting the print side (one-sided or two-sided printing). The print side setting is unnecessary for the print job ticket but is required for the print ticket. Setting items 618 to 621 enable selecting the paper orientation (portrait or landscape). The paper orientation setting is required for the print job ticket but is arbitrary for the print ticket. Setting items 622 to 625 enable selecting the print color (monochrome or color). The print color setting item is arbitrary for the print job ticket but is required for the print ticket. Setting items 626 to 629 enable numerically setting the width of the finishing size. The width setting for the finishing size is arbitrary for the print job ticket but is unnecessary for the print ticket. Setting items 630 to 633 enable selecting the bookbinding method (saddle stitch or perfect binding). The bookbinding setting item is arbitrary for the print job ticket but is unnecessary for the print ticket. A paper search button 634 calls a paper search screen for searching for paper pre-registered in the print order receiving and placing system. Setting items 635 to 642 in list form indicate the applicable paper information selected in the above-described paper search screen: an ID 635, a paper name 636, a manufacturer name 637, and a paper size 638 of the first applicable paper, and an ID 639, a paper name 640, a manufacturer name 641, and a paper size 642 of the second applicable paper. A registration button 643 accepts an operator's instruction for registering the relevant device with the above-described input setting items, and registers the current setting items in the data storage unit 325. A cancel button 644 accepts an operator's instruction for canceling the device registration.

The device search screen called by the device search button 603 includes entry fields which allow the operator to input device-related narrow-down conditions, such as a device ID, a device name, a manufacturer name, and applicable paper. The device search screen further includes a search button for searching for a device which satisfies the narrow-down conditions input in the entry fields. Upon reception of the pressing of the search button from the operator, the device search screen transfers the input narrow-down conditions to the search unit 319. The search unit 319 searches for device information stored in the data storage unit 325 based on the specified narrow-down conditions, and returns the result of the search to the device management unit 309. The device management unit 309 displays the received search result on the information display unit 329 via the information processing unit 328. The search result is displayed as the device information displayed in list form. When the operator selects a target device, information about the selected device is reflected to each setting item of the device registration screen 601. The operator is able to edit and register desired input items. The above-described mechanism enables the operator to register a new device without inputting information about the relevant device from the beginning. The paper search screen called by the above-described paper search button 634 is similar to the paper search screen described in paper registration. When the operator selects paper in the paper search screen, the relevant paper is appended to the applicable paper list of the device registration screen 601. When paper is appended, the relevant device is associated with the paper usable for the device.

The following describes an example of a setting item appending screen called by the above-described setting item appending buttons 610 to 613, with reference to FIG. 9.

FIG. 9 illustrates a setting item appending screen 701 for appending a setting item of the selection type. A class 702 indicates the class of the setting item. A setting item name 703 indicates the name of the setting item. A print job ticket setting 704 indicates whether setting is made to the print job ticket and, when setting is made, whether the relevant setting is optional or required. A print ticket setting 705 indicates whether setting is made to the print ticket and, when setting is made, whether the relevant setting is optional or required. A setting 706 is set when setting a setting item to the print job ticket and the print ticket. A registration button 707 receives an operator's instruction for appending the relevant setting item with the above-described input setting items, and registers the relevant setting item in the data storage unit 325. A cancel button 708 accepts an operator's instruction for canceling the appending of the relevant setting item. In the example illustrated in FIG. 9, the category is a general setting, the setting item name is “print side”, the print job ticket is not set, the print ticket setting is required, and setting items include “one-sided” and “two-sided” (selected by the operator). Providing the above-described setting items related to the relevant device enables displaying setting items according to the capabilities of the relevant device in print setting registration and print process registration (described below). Providing the above-described setting items also enables setting a setting item related to the print job ticket and the print ticket, without exception, when producing a print product using the relevant device.

In the above-described steps S201 and S202, initial setting for the print order receiving and placing system by the operator of the printing company 3 is completed.

<Processing Flow from Print Specification Adjustment to Item Registration>

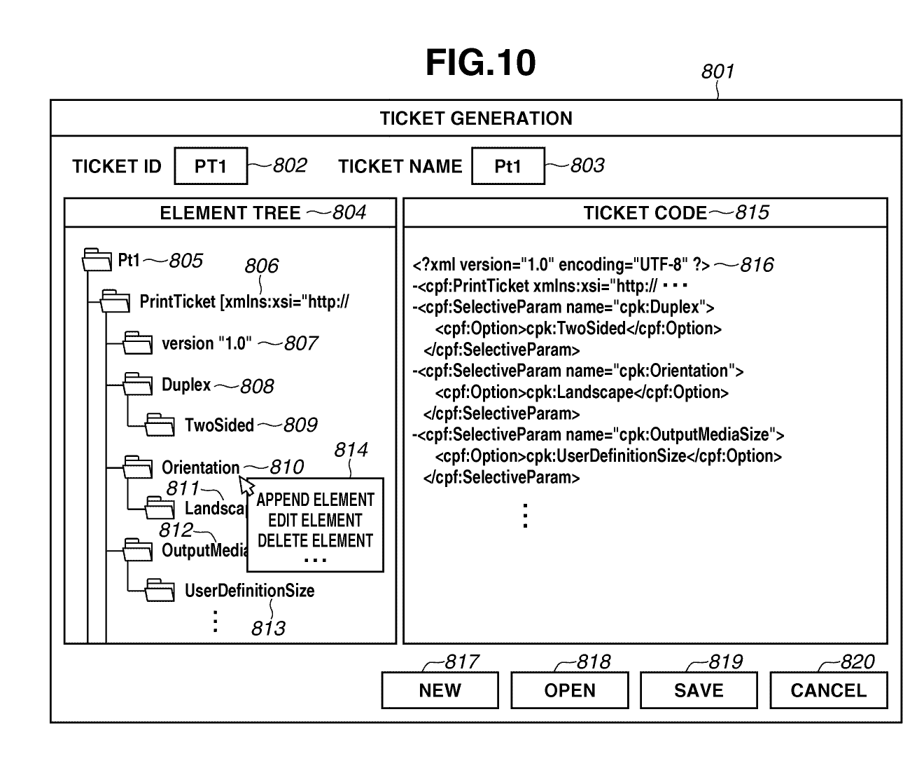

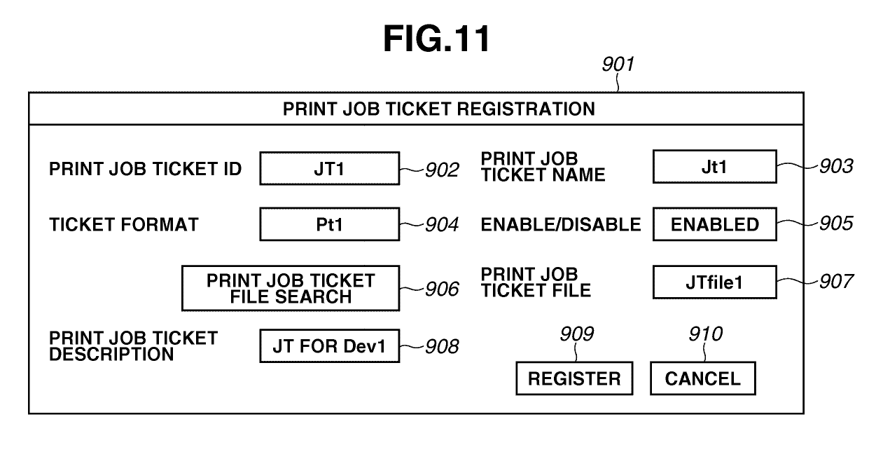

The following describes a sequence from print specification adjustment to item registration, with reference to FIG. 5B. In step S203, the purchaser and the printing company 3 adjust a print specification of a print product. Since the adjustment method has already been described in step S102, detailed description thereof will be omitted. In step S204, the ticket management unit 310 displays a ticket generation screen illustrated in FIG. 10 on the information display unit 329, prompts the operator to generate a ticket, receives a ticket from the ticket registration screen illustrated in FIG. 11, and stores the ticket in the data storage unit 325. However, at this timing, pieces of information to be determined after order reception, such as the number of print copies, have not been set to the print job ticket and the print ticket. Therefore, at this timing, the ticket serves as a template. These pieces of information not set will be input after order reception, and then the ticket is completed.

The following describes procedures for generating a print ticket, with reference to FIG. 10.

FIG. 10 illustrates a ticket generation screen 801 for generating a ticket. A ticket ID 802 and a ticket name 803 are used to identify the ticket. An element tree 804 visually represents tree-structured elements constituting the ticket. A first layer element 805 is at the highest level of the ticket. A second layer element 806 of the ticket is a child element of the first layer element 805. Third layer elements 807, 808, 810, and 812 of the ticket are child elements of the second layer element 806. Fourth layer elements 809, 811, and 813 of the ticket are child elements of the third layer elements 808, 810, and 812, respectively. A context menu 814 is displayed on the element tree 804. A ticket code display field 815 displays the contents of the ticket. A ticket code 816 indicates the contents of the ticket. A new generation button 817 generates a new ticket. An open button 818 reads an existing ticket and displays relevant values in the ticket ID 802, the ticket name 803, the element tree 804, and the ticket code display field 815. A save button 819 stores the ticket currently being edited in the data storage unit 325. A cancel button 820 accepts an operator's instruction for canceling the ticket generation.

The above-described context menu 814 calls functions of editing the element tree or an element, such as “APPEND ELEMENT”, “EDIT ELEMENT”, and “DELETE ELEMENT”. “APPEND ELEMENT” appends a new element to the element tree. “EDIT ELEMENT” allows the operator to edit the contents of an existing element. “DELETE ELEMENT” deletes a selected element from the element tree. In the example illustrated in FIG. 10, the print ticket code is described with the Extensible Markup Language (XML) version 1.0. The XML is a general-purpose markup language prescribed by the standardization organization World Wide Web Consortium. The print ticket code indicates two-sided printing (TwoSided), a horizontal paper orientation (Landscape), and a user-defined output size (UserDefinitionSize). Since the print job ticket and the processing job ticket are described in the same XML format as the print ticket, the ticket generation screen 801 can also be used not only to generate a print ticket but also to generate a print job ticket and a processing job ticket.

The following describes a ticket registration screen for registering the ticket generated by using the ticket generation screen 801 in the print order receiving and placing system. In the description, a print job ticket registration screen illustrated in FIG. 11 is used as an example. FIG. 11 illustrates a register print job ticket screen 901 for registering a print job ticket. A print job ticket ID 902 identifies the print job ticket to be registered. A print job ticket name 903 identifies the print job ticket. A ticket format 904 specifies a format of the relevant print job ticket. An enable/disable flag 905 indicates whether the use of the relevant print job ticket is enabled on the print order receiving and placing system. A print job ticket file search button 906 searches for a print job ticket file pre-registered in the print order receiving and placing system. A print job ticket file 907 indicates a file to be registered in the print order receiving and placing system. A print job ticket description 908 describes the relevant print job ticket. A registration button 909 accepts an operator's instruction for registering the relevant print job ticket with the above-described input setting items, and registers the current setting items in the data storage unit 325. A cancel button 910 accepts an operator's instruction for canceling the print job ticket registration. Upon reception of the press of the ticket registration button of the menu screen 401 by the operator, the print order receiving and placing system displays the print job registration ticket screen 901 on the information display unit 329. The ticket management unit 310 issues a new print job ticket ID, displays the new print job ticket in the print job ticket ID 902, and waits for an input from the operator. Upon reception of the press of the print job ticket file search button 906 by the operator, the ticket management unit 309 displays a print job ticket file search screen for searching for a print job ticket pre-registered in the print order receiving and placing system. Upon reception of file specification from the operator, the ticket management unit 309 reflects the name of the relevant file on the print job ticket file 907. Upon reception of the press of the registration button 909 from the operator, the ticket management unit 309 acquires the contents of the input items, such as a print job ticket name input by the operator, and stores the input items in the data storage unit 325.

### <Registering a Print Setting>

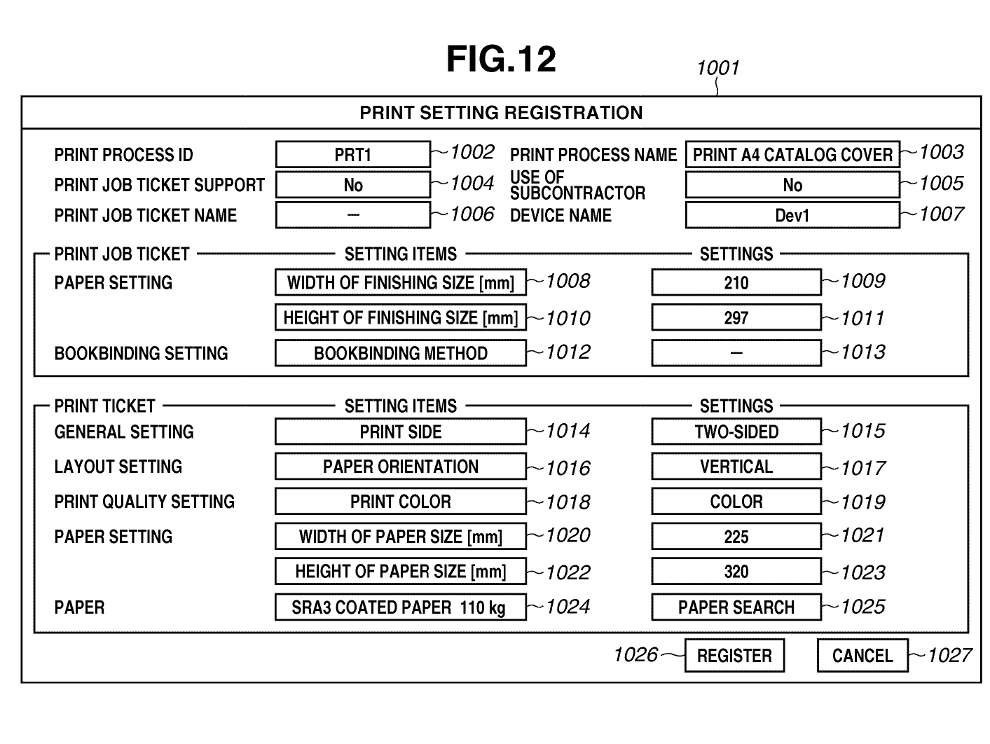

In step S205, the print setting management unit 311 receives information about a print setting input in a print setting registration screen illustrated in FIG. 12 displayed on the information display unit 329, and stores the print setting in the data storage unit 325.

An example of a method for registering a print setting will be described below with reference to FIG. 12. FIG. 12 illustrates a register print setting screen 1001 for registering a print setting. Setting items 1002 to 1007 are related to the relevant print setting, and include a print process ID 1002, a print process name 1003, a print job ticket support flag 1004 (indicating whether the relevant print setting supports a print job ticket), a use-of-subcontractor flag 1005 (indicating whether a subcontractor is to be used), a print job ticket name 1006, and a device name 1007. Setting items 1008 to 1023 are setting items and setting contents that can be set for the relevant print setting. A paper field 1024 displays the name of paper selected by using a paper search button 1027 (described below). A paper search button 1025 searches for paper to be used in the relevant print setting from the pre-registered paper information. A registration button 1026 accepts an operator's instruction for registering the relevant print setting with the above-described input setting items, and registers the current setting items in the data storage unit 325. A cancel button 1027 accepts an operator's instruction for canceling the print setting registration. A target device can be selected from the devices registered in step S202 and then set in the device name 1007. The device set in the device name 1007 is associated with the relevant print setting. Upon reception of device name setting in the device name 1007, the print setting management unit 311 displays setting items which should be set in the print job ticket display field and the print ticket display field out of setting items registered in the device registration screen 601. That is, the print setting management unit 311 displays setting items with which the print job ticket column and the print ticket column are set to required or optional in the device registration screen 601. When paper is set in the paper field 1024, the relevant print setting is associated with the paper.

### <Registering a Print Process>

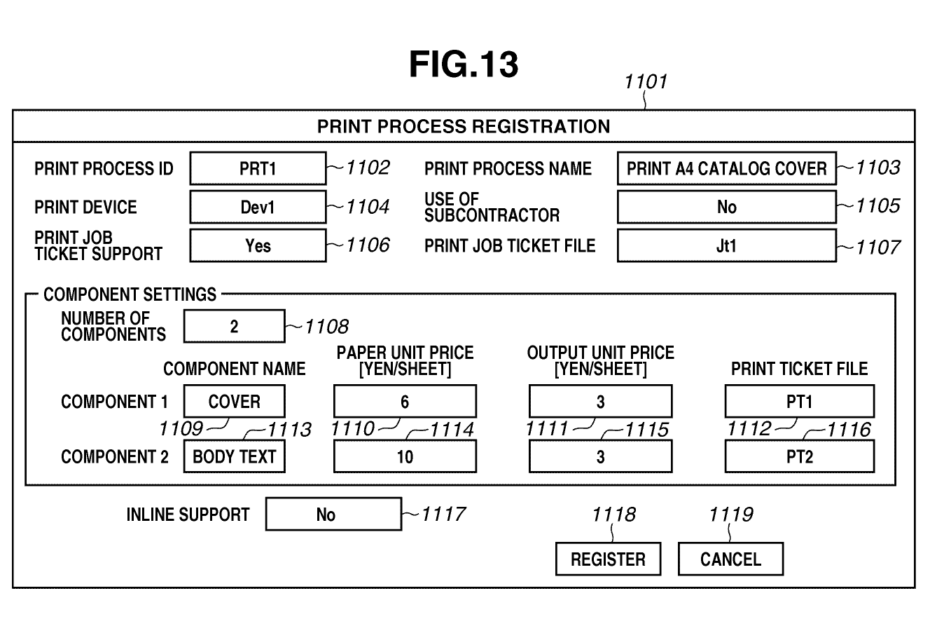

In step S206, the print process management unit 312 receives information about a print process input in a print process registration screen illustrated in FIG. 13 displayed on the information display unit 329, and stores the information in the data storage unit 325.

The print process registration screen is illustrated in FIG. 13. FIG. 13 illustrates a print process registration screen 1101 for registering information about a print process, such as components constituting the relevant print process, a printing machine to be used, and a print job ticket. A print process ID 1102 identifies the print process. Setting items 1103 to 1107 include a print process name 1103, a print device 1104, a use-of-subcontractor flag 1105 (indicating whether a subcontractor is to be used), a print job ticket support flag 1106 (indicating whether the relevant print setting supports a print job ticket), and a print job ticket file 1107 to be used by the relevant print process. Setting items 1108 to 1116 are related to components constituting the relevant print process. The number of components 1108 indicates the number of components constituting the relevant print process. The setting items 1109 to 1112 are related to the first component, and include a component name 1109, a paper unit price per sheet 1110 which is a reference price for estimation, an output unit price (printing fee) per sheet 1111, and a print ticket file 1112 used to print the relevant component. The setting items 1113 to 1116 are equivalent to the above-described setting items 1109 to 1112 for the second component. An in-line support flag 1117 indicates whether the relevant print process supports in-line processing (processing for connecting the printing machine and the processing machine in series, and performing the print process and the processing process in sequence). A registration button 1118 accepts an operator's instruction for registering the relevant print process with the above-described input setting items, and registers the current setting items in the data storage unit 325. A cancel button 1119 accepts an operator's instruction for canceling the print process registration.

Although not illustrated in FIG. 13, the print process registration screen 1101 may be provided with a button for calling a print process search screen for searching for a pre-registered print process, as with the above-described paper register screen 501. Needless to say, the operator may be able to select a desired print job ticket file and a print ticket file, and read them from the print process search screen. When the operator specifies a print job ticket file 1107 and print ticket files 1112 and 1116, the print job ticket file and the print ticket files are associated with the relevant print process.

### <Registering a Processing Process>

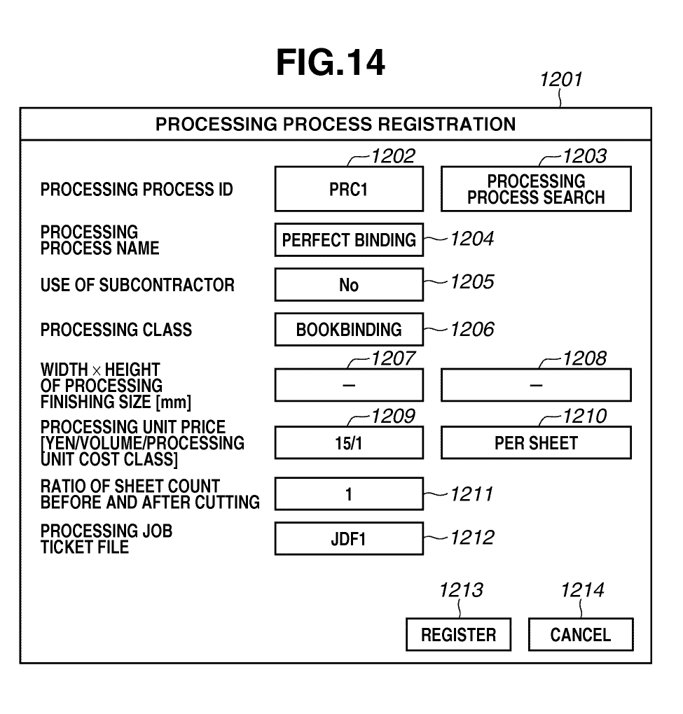

In step S207, the processing process management unit 313 receives information about a processing process input to a processing process registration screen illustrated in FIG. 14 displayed on the information display unit 329, and stores the information in the data storage unit 325.

FIG. 14 illustrates a register processing process screen 1201 for registering a processing process. A processing process ID 1202 identifies the processing process. A search for processing process button 1203 searches for a pre-registered processing process. A processing process name 1204 indicates the name of the processing process. A use-of-subcontractor flag 1205 indicates whether a subcontractor is to be used. A processing class 1206 indicates the class of processing, such as bookbinding, cutting, and folding. A width 1207 and a height 1208 indicate the width and the height of the processing finishing size, respectively. A processing unit cost 1209 indicates a processing unit cost per processing unit cost class per volume of a processing unit cost class 1210 (described below). A processing unit cost class 1210 indicates a processing unit per sheet per volume for representing the processing unit price. A ratio of sheet counts before and after cutting 1211 indicates the ratio of the number of sheets increased after cutting to the number of sheets before cutting when the processing class 1206 is cutting. A processing job ticket file 1212 specifies a processing job ticket file to be used in the relevant processing process. A registration button 1213 accepts an operator's instruction for registering the relevant processing process with the above-described input setting items, and registers the current setting items in the data storage unit 325. A cancel button 1214 accepts an operator's instruction for canceling the processing process registration. Upon reception of the press of the search for processing process button 1203 from the operator, the processing process management unit 313 displays on the information display unit 329 a processing process search screen for searching for a pre-registered processing process. The processing process search screen is provided with entry fields for inputting narrow-down conditions, such as a processing process ID, a processing process name, a processing class, and a related processing job ticket file, as with the above-described paper search screen and device search screen. The processing process search screen is further provided with a search button for searching for a processing process which satisfies the narrow-down conditions input in the entry fields, and an apply button for reflecting to the register processing process screen 1201 a processing process selected from the search result. When the operator presses the apply button, the processing process management unit 312 reflects to each setting item in the register processing process screen 1201 the processing process selected in the processing process search screen.

### <Registering a Product Specification>

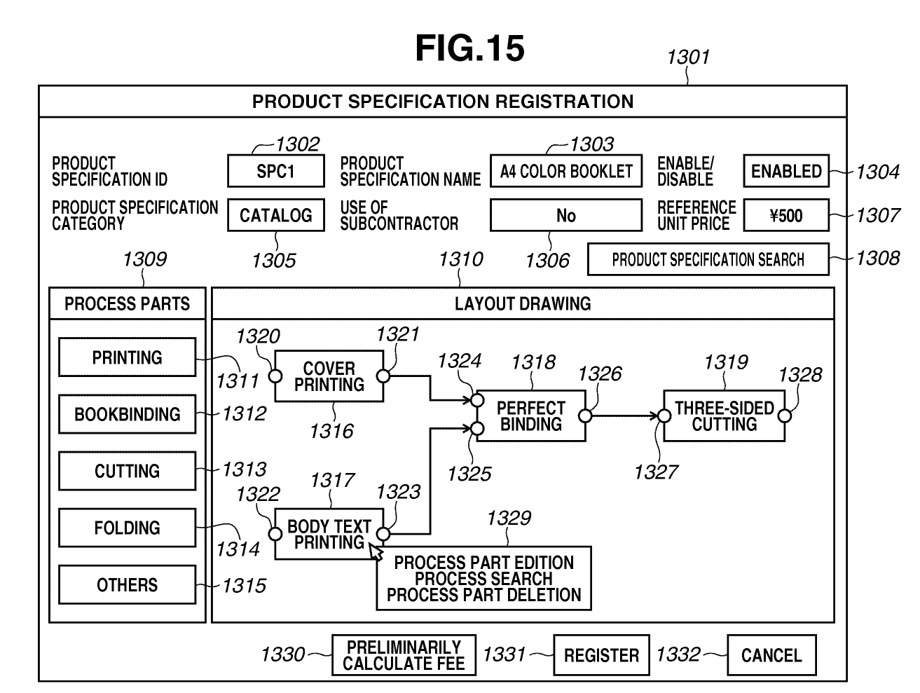

In step S208, the product specification management unit 314 receives information about a product specification input to a product specification registration screen illustrated in FIG. 15 displayed on the information display unit 329, and stores the information in the data storage unit 325.

FIG. 15 illustrates a product specification registration screen 1301 for registering a product specification. A product specification ID 1302 is issued from the product specification management unit 314 when a new product specification is registered. A product specification name 1303 indicates the name of the product specification. An enable/disable flag 1304 indicates whether the use of the relevant product specification is enabled on the print order receiving and placing system. A product specification category 1305 indicates the category of the relevant product specification. A use-of-subcontractor flag 1306 indicates whether a subcontractor is to be used. A reference unit price 1307 indicates the unit price of the relevant product specification. A product specification search button 1308 searches for a pre-registered product specification. A process parts menu 1309 collects process part icons indicating processes, such as printing and bookbinding. A layout drawing 1310 is used to arrange process part icons of processes for producing a print product. Process part icons 1311 to 1315 include a printing icon 1311 indicating a print process, a bookbinding icon 1312 indicating a bookbinding process, a cutting icon 1313 indicating a cutting process, a folding icon 1314 indicating a folding process, and other icon 1315 indicating a process other than the above-described four processes. Process part icons 1316 to 1319, arranged in the layout drawing 1310 and edited by the operator, are used to generate a perfect binding booklet. A cover printing icon 1316 indicates a cover print process. A body text printing icon 1317 indicates a body text print process. A perfect binding icon 1318 indicates a perfect binding process for binding the print product printed by the body text print process and the cover print process. A three-sided cutting icon 1319 indicates a cutting process for cutting the three edges (the upper edge (top), the lower edge (bottom), and the side edge not bound (fore-edge)) of the print product bound by the perfect binding process. Terminals 1320 to 1328 are used to connect processes arranged in the layout drawing 1310. The input terminals 1320 and output terminal 1321 belonging to the cover printing icon 1316 are an input terminal to the cover printing icon 1316 and an output terminal from the cover printing icon 1316, respectively. The input terminal 1322 and output terminal 1323 belonging to body text printing icon 1317 are an input terminal to the body text printing icon 1317 and an output terminal from the body text printing icon 1317, respectively. The input terminals 1324 and 1325 and output terminal 1326 belonging to the perfect binding icon 1318 are input terminals to the perfect binding icon 1318 and an output terminal from the perfect binding icon 1318, respectively. The input terminal 1327 and output terminal 1328 belonging to the three-sided cutting icon 1319 are an input terminal to the three-sided cutting icon 1319 and an output terminal from the three-sided cutting icon 1319, respectively. A context menu 1329 is displayed when the operator selects a process part icon arranged in the layout drawing 1310. The context menu 1329 includes an editing menu (process part edition) for editing the contents of the selected process part, a process search menu (process search) calling a print process search screen for searching for a process applicable to the selected process part in pre-registered printing processes and processing processes, and a deletion menu (process part deletion) for deleting the selected process part from the list of process parts constituting the product specification and from the layout drawing 1310. A preliminarily fee calculation button 1330 calls a screen for preliminarily calculating a printing fee required to produce a print product based on the process parts arranged in the layout drawing 1310. A registration button 1331 accepts an operator's instruction for registering the relevant product specification with the above-described input setting items, and registers the current setting items in the data storage unit 325. A cancel button 1332 accepts an operator's instruction for canceling the product specification registration. In the above-described layout drawing 1310, when the operator selects a process part icon already arranged with the cursor, and moves (drags) it to another position in the layout drawing 1310, the position of the relevant process part icon can be changed in the layout drawing 1310. Further, when the operator selects an output terminal of a process part icon and drags it onto an input terminal of another process part icon, the output terminal and the input terminal are connected with an arrow line. When the operator selects a connected terminal and drag it onto the layout drawing 1310, the connection can be canceled. In the layout drawing 1310, the operator is able to move process part icons, connect terminals, and cancel connection between terminals, as described above. Techniques related to these operations are well-known, and detailed description thereof will be omitted.

The print product illustrated in the layout drawing 1310 illustrated in FIG. 15 is an example of a case where a cover and a body text are printed as different processes, and then perfect binding and three-sided cutting are performed. In this case, as illustrated in the layout drawing 1310 illustrated in FIG. 15, the relevant print product can be defined by connecting the cover printing icon 1316 and the body text printing icon 1317 to the perfect binding icon 1318, and then connecting the perfect binding icon 1318 to the three-sided cutting icon 1319. Further, when the operator arranges the process part icons in the layout drawing 1310, suitably edits the contents, and presses the registration button 1331, each process is associated with the product specification.

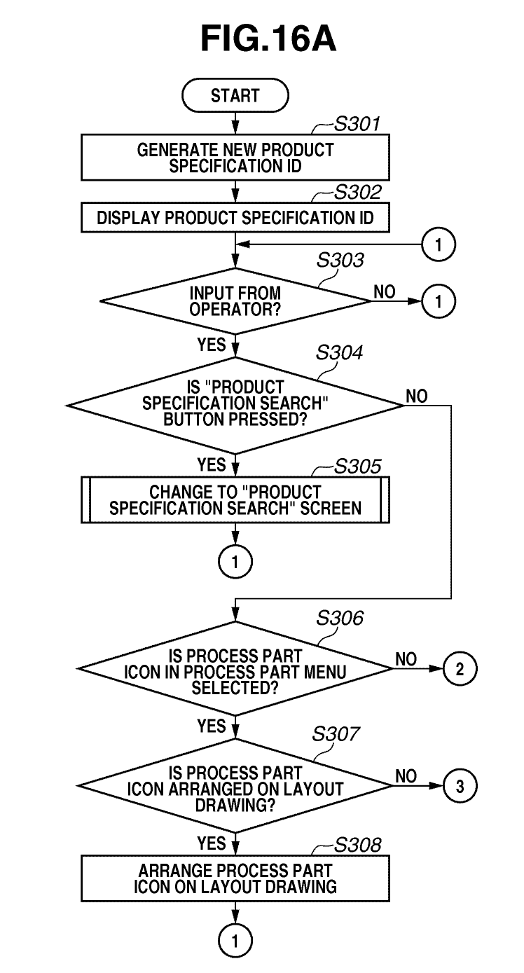

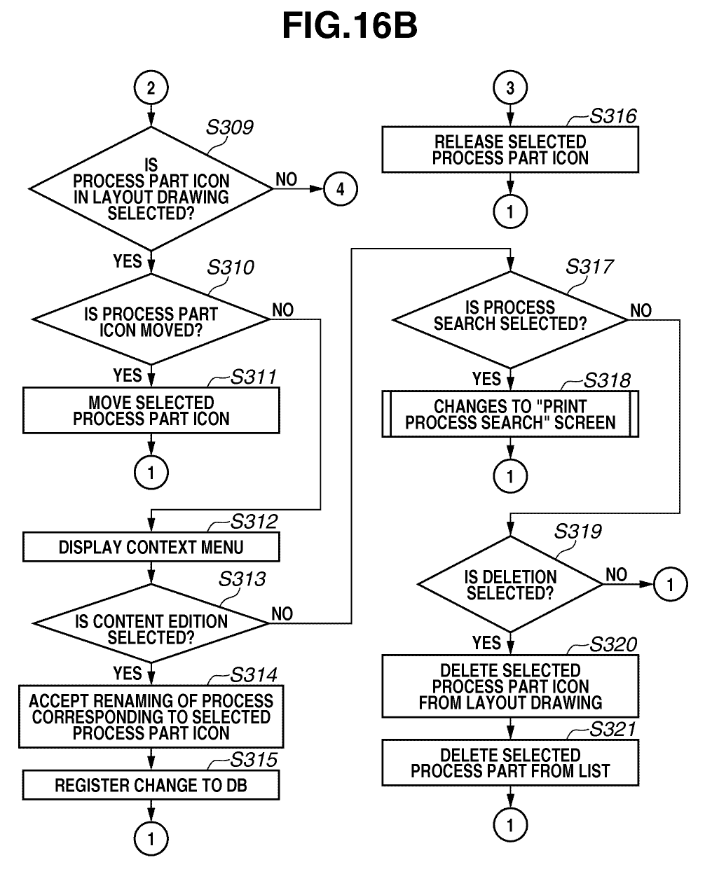

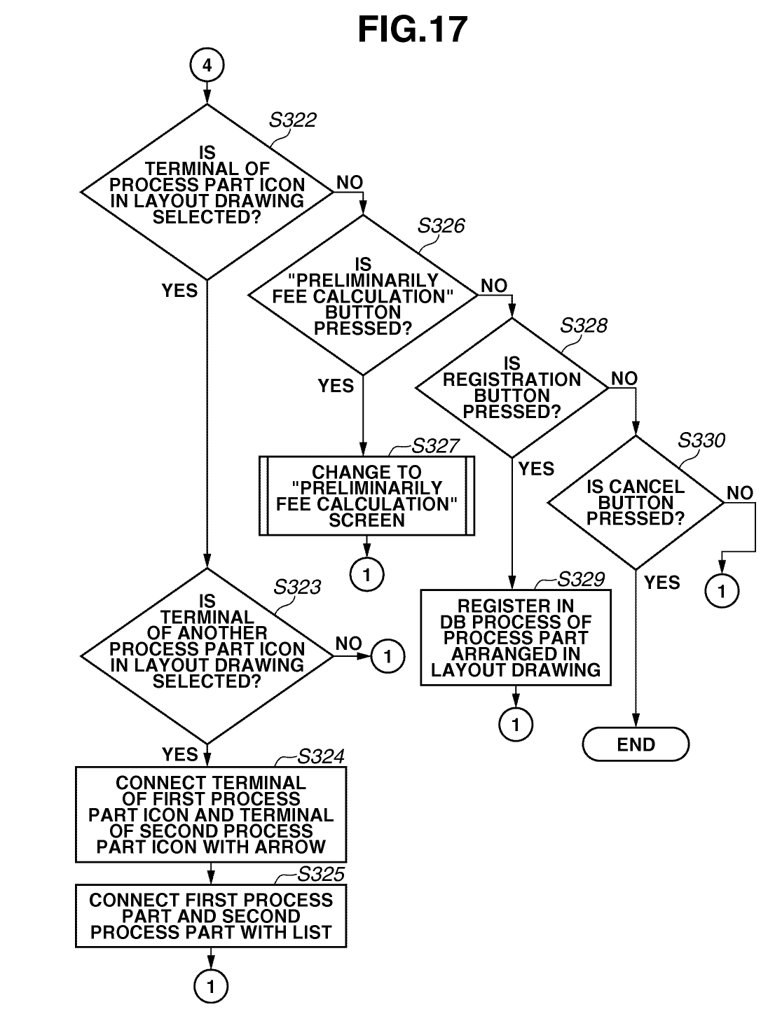

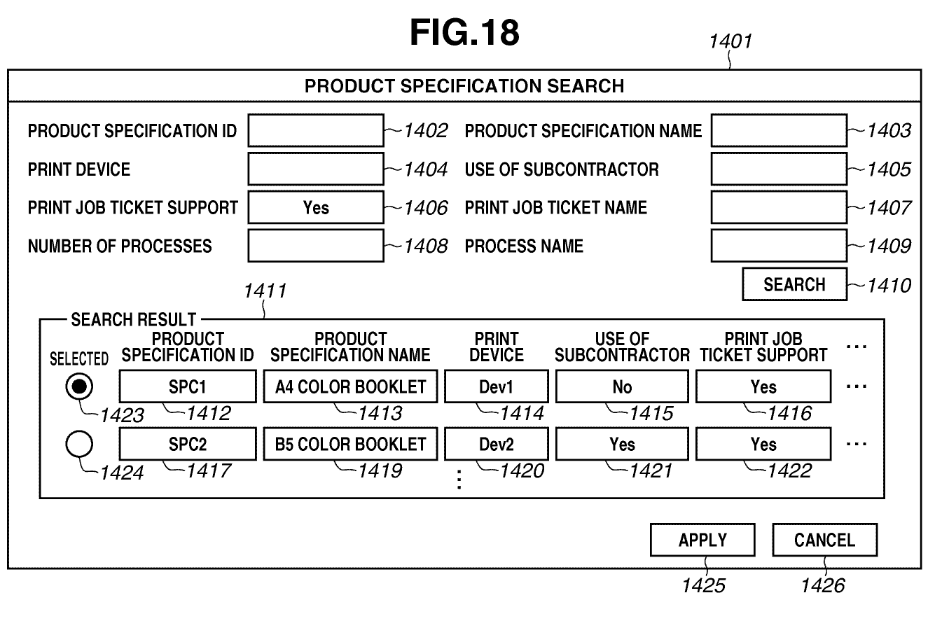

The following describes processing in the product specification registration screen 1301 with reference to FIGS. 16 and 17. In step S301, upon reception of a product specification registration screen display request from the operator via the instruction input unit 327 and the information processing unit 328, the product specification management unit 314 generates a new product specification ID with reference to the product specification ID stored in the data storage unit 325. In step S302, the product specification management unit 314 transmits the relevant product specification ID to the information processing unit 328, and the information processing unit 328 displays the product specification ID on the information display unit 329. In step S303, the product specification management unit 314 waits for an input from the operator. When an input has been received from the operator (YES in step S303), the processing proceeds to step S304. On the other hand, when no input has been received from the operator (NO in step S303), the processing returns to step S303. In step S304, the product specification management unit 314 waits until the operator presses the product specification search button 1308. When the product specification search button 1308 has been pressed (YES in step S304), the processing proceeds to step S305. On the other hand, when the product specification search button 1308 has not been pressed (NO in step S304), the processing proceeds to step S306. In step S305, the product specification management unit 314 displays a product specification search screen illustrated in FIG. 18 on the information display unit 329. When the operator searches for and select a product specification and then presses an apply button 1425 in the product specification search screen, information about the selected product specification is read and reflected to each setting item in the product specification registration screen 1301.

FIG. 18 illustrates a product specification search screen 1401 for searching for a product specification pre-registered in the print order receiving and placing system. Narrow-down condition entry fields 1402 to 1409 input narrow-down conditions for narrowing down pre-registered product specifications when searching for a product specification. Narrow-down conditions 1402 to 1409 include a product specification ID 1402, a product specification name 1403, a printing device 1404, a use-of-subcontractor flag 1405, a print job ticket support flag 1406, a print job ticket name 1407, the number of processes 1408, and a process name 1409. A search button 1410 searches for a product specification based on the conditions input in the above-described narrow-down condition entry fields 1402 to 1409. A search result display field 1411 displays the search result, i.e., a product specification extracted by search processing. Product specification attributes 1412 to 1422 are extracted by the search processing. The product specification attributes 1412 to 1416 include a product specification ID 1412, a product specification name 1413, a printing device 1414, a use-of-contractor flag 1415, and a print job ticket support flag 1416 of the extracted first product specification. The product specification attributes 1417 to 1422 include a product specification ID 1417, a product specification name 1419, a printing device 1420, a use-of-contractor flag 1421, and a print job ticket support flag 1422 of the extracted second product specification. Radio buttons 1423 and 1424 are used to exclusively select the extracted first product specification or the extracted second product specification, respectively. An apply button 1425 reads a product specification selected by the radio button 1423 or 1424 into the product specification registration screen 1301. A cancel button 1426 accepts an operator's instruction for canceling the operations made on the product specification search screen 1401. Although the narrow-down conditions 1402 to 1409 are illustrated in the product specification search screen 1401 in FIG. 18, the narrow-down conditions are not limited thereto. For example, any condition for narrowing down product specifications, such as a date of product specification registration, may be included in the narrow-down conditions.

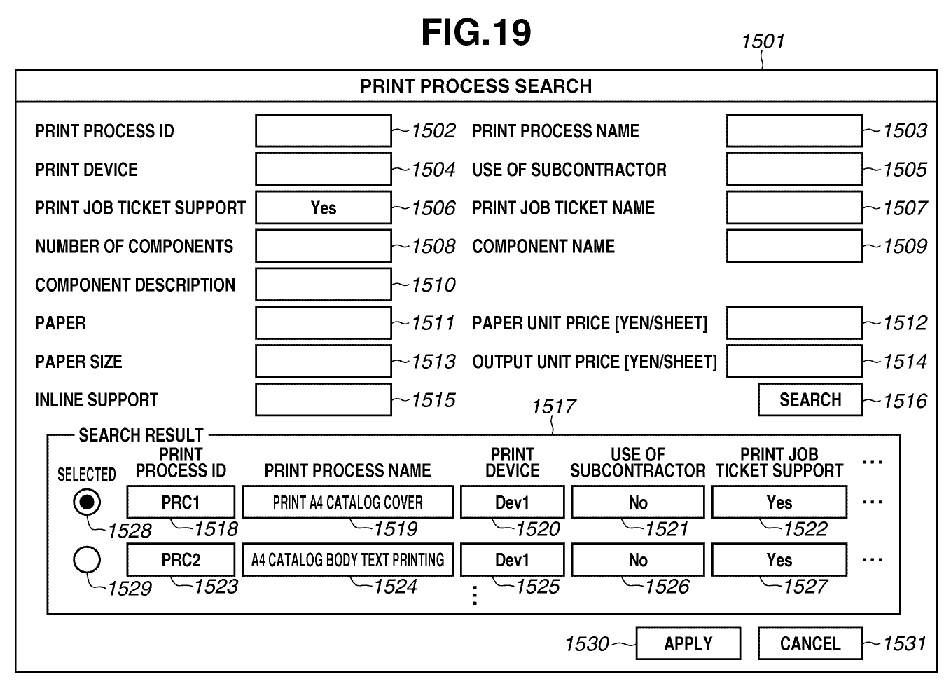

The example of the product specification search screen 1401 illustrated in FIG. 18 indicates that the operator searched for a product specification having the print job ticket support flags 1416 and 1422 set to YES (the result of the search is displayed in the search result display field 1411), and then selected the first product specification. In step S306, the product specification management unit 314 determines whether any one of the process part icons of the process part menu 1309 has been selected. When any one of the process part icons has been selected (YES in step S306), the processing proceeds to step S307. On the other hand, when no process part icon has been selected (NO in step S306), the processing proceeds to step S309. In step S307, the product specification management unit 314 determines whether the selected process part icon has been arranged in the layout drawing 1310. When the selected process part icon has been arranged in the layout drawing 1310 (YES in step S307), the processing proceeds to step S308. On the other hand, When the selected process part icon has not been arranged in the layout drawing 1310 (NO in step S307), the processing proceeds to step S316. In step S308, the provision unit 320 arranges the selected process part icon on the layout drawing 1310, and redraws the layout drawing 1310. In step S309, the product specification management unit 314 determines whether any one of the process part icons in the layout drawing 1310 has been selected. When any one of the process part icons has been selected (YES in step S309), the processing proceeds to step S310. On the other hand, when no process part icon has been selected (NO in step S309), the processing proceeds to step S322. In step S310, the product specification management unit 314 determines whether the selected process part icon has been moved. When the selected process part icon has been moved (YES in step S310), the processing proceeds to step S311. On the other hand, when the selected process part icon has not been moved (NO in step S310), the processing proceeds to step S312. In step S311, the provision unit 320 moves the selected process part icon, and re-draws the layout drawing 1310. In step S312, the product specification management unit 314 displays the context menu 1329 allowing the operator to select an operation for the selected process part icon. In step S313, the product specification management unit 314 determines whether “process part edition” of the context menu 1329 has been selected. When “process part edition” has been selected (YES in step S313), the processing proceeds to step S314. On the other hand, when “process part edition” has not been selected (NO in step S313), the processing proceeds to step S317. In step S314, the product specification management unit 314 receives renaming of a process (a print process name or a processing process name) corresponding to the selected process part icon. In step S315, the product specification management unit 314 renames the relevant process in the data storage unit 325 according to the renaming received in step S314. In step S316, the product specification management unit 314 deselects the process part icon selected in step S306. In step S317, the product specification management unit 314 determines whether “process search” of the context menu 1329 has been selected. When “process search” has been selected (YES in step S317), the processing proceeds to step S318. On the other hand, when “process search” has not been selected (NO in step S317), the processing proceeds to step S319. In step S318, the product specification management unit 314 displays a print process search screen illustrated in FIG. 19. When the operator searches for and selects a process in the print process search screen and then presses an apply button 1530 (described below), information about the selected process is read and reflected to the process selected in the layout drawing 1310.

FIG. 19 illustrates a print process search screen 1501 for searching for a print process pre-registered in the print order receiving and placing system. Narrow-down condition entry fields 1502 to 1515 are used to input narrow-down conditions for narrowing down print processes when searching for a print process. Narrow-down conditions 1502 to 1515 include a print process ID 1502, a print process name 1503, a printing device 1504, a use-of-subcontractor flag 1505, a print job ticket support flag 1506, a print job ticket name 1507, the number of components 1508 constituting the print process, a component name 1509, a component description 1510, paper 1511, a paper unit price 1512, a paper size 1513, an output unit price 1514, and an in-line support flag 1515. A search button 1516 searches for a print process based on the conditions input in the above-described narrow-down condition entry fields 1502 to 1515. A search result display field 1517 displays the search result, i.e., a print process extracted by search processing. Print process attributes 1518 to 1527 are extracted by search processing. The print process attributes 1518 to 1522 includes a print process ID 1518, a print process name 1519, a printing device 1520, a use-of-subcontractor flag 1521, and a print job ticket support flag 1522 of the first print process extracted. The print process attributes 1523 to 1527 include a print process ID 1523, a print process name 1524, a printing device 1525, a use-of-subcontractor flag 1526, and a print job ticket support flag 1527 of the second print process extracted. Radio buttons 1528 and 1529 are used to exclusively select the first print process or the second print process extracted, respectively. An apply button 1530 reads the print process selected by the radio button 1528 or 1529 into the print process selected in step S309. A cancel button 1531 accepts an operator's instruction for canceling the operations made on the print process search screen 1501.

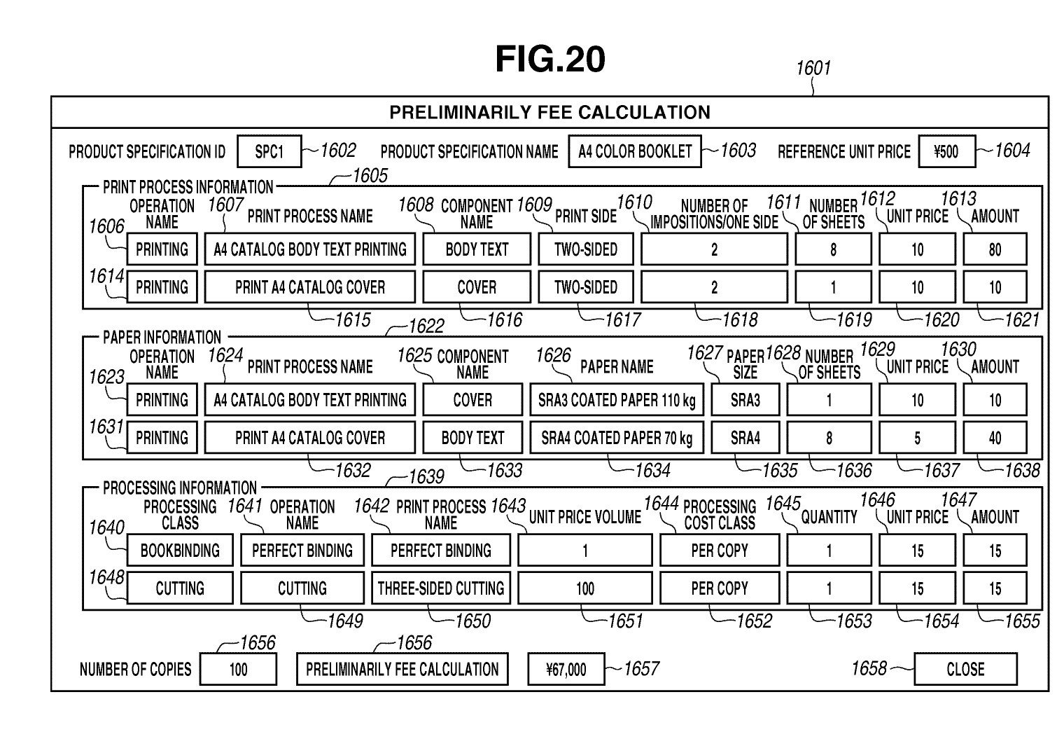

In step S319, the product specification management unit 314 determines whether “process part deletion” of the context menu 1329 has been selected. When “process part deletion” has been selected (YES in step S319), the processing proceeds to step S320. On the other hand, when “process part deletion” has not been selected (NO in step S319), the selection is cancelled and the processing returns to step S303. In step S320, the provision unit 320 deletes the selected process part icon from the layout drawing 1310, and updates the drawing of layout drawing 1310. In step S321, the product specification management unit 314 deletes the selected process part from the connection list of processes constituting the product specification. In step S322, the product specification management unit 314 determines whether a terminal of a process part icon in the layout drawing 1310 has been selected. When a terminal of a process part icon has been selected (YES in step S322), the processing proceeds to step S323. On the other hand, when no terminal of a process part icon has been selected (NO in step S322), selection is canceled and the processing proceeds to step S326. In step S323, the product specification management unit 314 determines whether a terminal of another process part icon in the layout drawing 1310 has been selected. When a terminal of another process part icon has been selected (YES in step S323), the processing proceeds to step S324. On the other hand, when no terminal of another process part icon has been selected (NO in step S323), the processing returns to step S303. In step S324, the provision unit 320 connects the terminal of the process part icon (hereinafter referred to as first process part icon) selected in step S322 and the terminal of the process part icon (hereinafter referred to as second process part icon) selected in step S323 with an arrow line, and re-draws the layout drawing 1310. In step S325, the product specification management unit 314 connects the first process part and the second process part in the connection list of processes constituting the product specification. In step S326, the product specification management unit 314 determines whether the preliminary fee calculation button 1330 has been pressed by the operator. When the preliminarily fee calculation button 1330 has been pressed (YES in step S326), the processing proceeds to step S327. On the other hand, when the preliminary fee calculation button 1330 has not been pressed (NO in step S326), the processing proceeds to step S328. In step S327, the product specification management unit 314 displays a preliminary fee calculation screen illustrated in FIG. 20 on the information display unit 329.

FIG. 20 illustrates a preliminary fee calculation screen 1601 for preliminarily calculating a printing fee based on the relevant product specification. Setting items include a product specification ID 1602, a product specification name 1603, and a reference unit price 1604 set in the product specification. A print process information display field 1605 displays information about print processes constituting the product specification. Print process attributes 1606 to 1621 constituting the product specification include print process attributes 1606 to 1613 for the first print process, and print process attributes 1614 to 1621 for the second print process (an operation name, a print process name, a component name, a print side, the number of impositions, the number of sheets, a unit price, and an amount). A paper information display field 1622 displays paper information used by each print process. Paper information attributes 1623 to 1638 used in each print process include paper information attributes 1623 to 1630 for the first print process, and paper information attributes 1631 to 1638 for the second print process (an operation name, a print process name, a component name, a sheet name, a paper size, the number of sheets, a unit price, and an amount). A processing information display field 1639 displays information about processing processes constituting the product specification. Processing process attributes 1640 to 1655 constituting the product specification include processing process attributes 1640 to 1647 for the first processing process, and processing process attributes 1648 to 1655 for the second processing process (a processing class, an operation name, a processing process name, a unit price volume, a processing cost class, a quantity, a unit price, and an amount). A number-of-volumes entry field 1656 allows the user to input the number of copies. A preliminary fee calculation button 1656 preliminarily calculates a printing fee based on the amount of money of the above-described reference unit price 1604, the amounts in the print process information display field 1605, the amounts in the paper information display field 1622, the amounts in the processing information display field 1639, and the number of copies input in the number-of-copies entry field 1656. A printing fee display field 1657 displays the printing fee preliminarily calculated by the depression of the preliminary fee calculation button 1656. A close button 1658 closes the preliminary fee calculation screen 1601. In addition, a save button for storing the result of the preliminary fee calculation in a file, and a print button for printing may be provided.

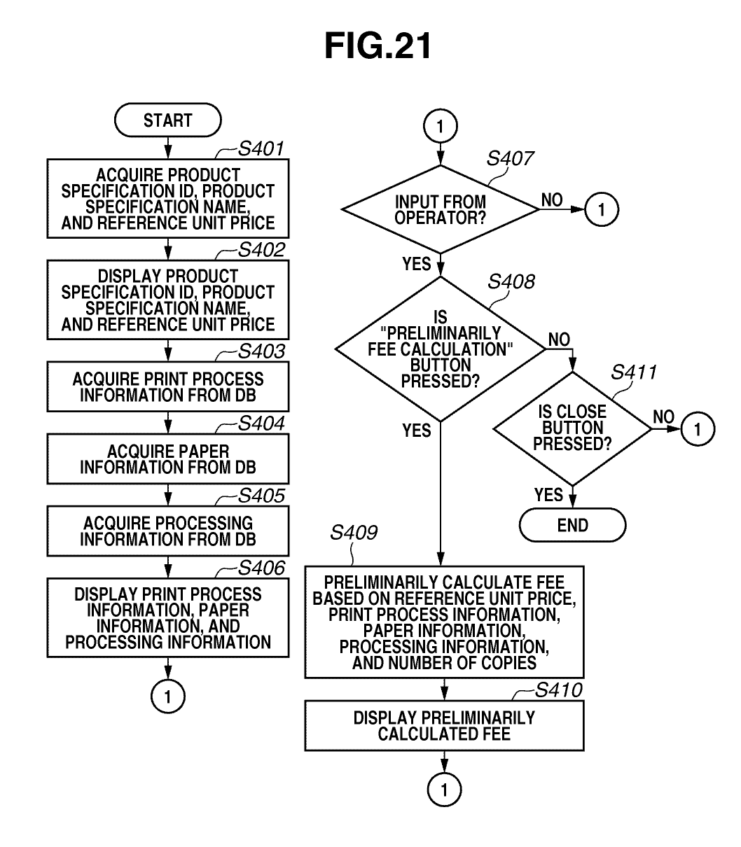

In step S328, the product specification management unit 314 determines whether the registration button 1331 has been pressed by the operator. When the registration button 1331 has been pressed (YES in step S328), the processing proceeds to step S329. On the other hand, when the registration button 1331 has not been pressed (NO in step S328), the processing proceeds to step S330. In step S329, the product specification management unit 314 stores in the data storage unit 325 the process part attributes arranged in the layout drawing 1310, and the processing returns to step S303. In step S330, the product specification management unit 314 determines whether the cancel button 1332 has been pressed by the operator. When the cancel button 1332 has been pressed (YES in step S330), the product specification registration processing is terminated. On the other hand, when the cancel button 1332 has not been pressed (NO in step S330), the processing returns to step S303. The following describes the processing for preliminarily calculating a printing fee with reference to FIG. 21. In step S401, the product specification management unit 314 acquires a product specification ID, a product specification name, and a reference unit price from the data storage unit 325. In step S402, the product specification management unit 314 displays in respective display fields in the preliminary fee calculation screen 1601 the product specification ID, the product specification name, and the reference unit price acquired in step S401. In step S403, the product specification management unit 314 acquires from the data storage unit 325 a print process associated with the product specification. In step S404, the product specification management unit 314 acquires from the data storage unit 325 paper information described in the print setting associated with the print process acquired in step S403. In step S405, the product specification management unit 314 acquires from the data storage unit 325 the processing process associated with the product specification. In step S406, the product specification management unit 314 displays in respective display fields in the preliminary fee calculation screen 1601 pieces of information acquired in steps S403 to S405. In step S407, the product specification management unit 314 waits for an input from the operator. When an input has been received (YES in step S407), the processing proceeds to step S408. On the other hand, when no input has been received (NO in step S407), the processing returns to step S407. In step S408, the product specification management unit 314 determines whether a preliminary fee calculation button 1656 has been pressed. When the preliminary fee calculation button 1656 has been pressed (YES in step S408), the processing proceeds to step S409. On the other hand, when the preliminary fee calculation button 1656 has not been pressed (NO in step S408), the processing proceeds to step S411. In step S409, the product specification management unit 314 calculates a fee based on the reference unit price of the product specification, each print process associated with the product specification, the paper, the amount for each processing process, and the number of copies. In step S410, the product specification management unit 314 displays the fee calculated in step S409 in a printing fee display field 1657 in the preliminary fee calculation screen 1601. In step S411, the product specification management unit 314 determines whether the close button 1658 has been pressed. When the close button 1658 has been pressed (YES in step S411), the preliminary fee calculation processing is terminated. On the other hand, when the close button 1658 has not been pressed (NO in step S411), the processing returns to step S407.

### <Registering a Product>

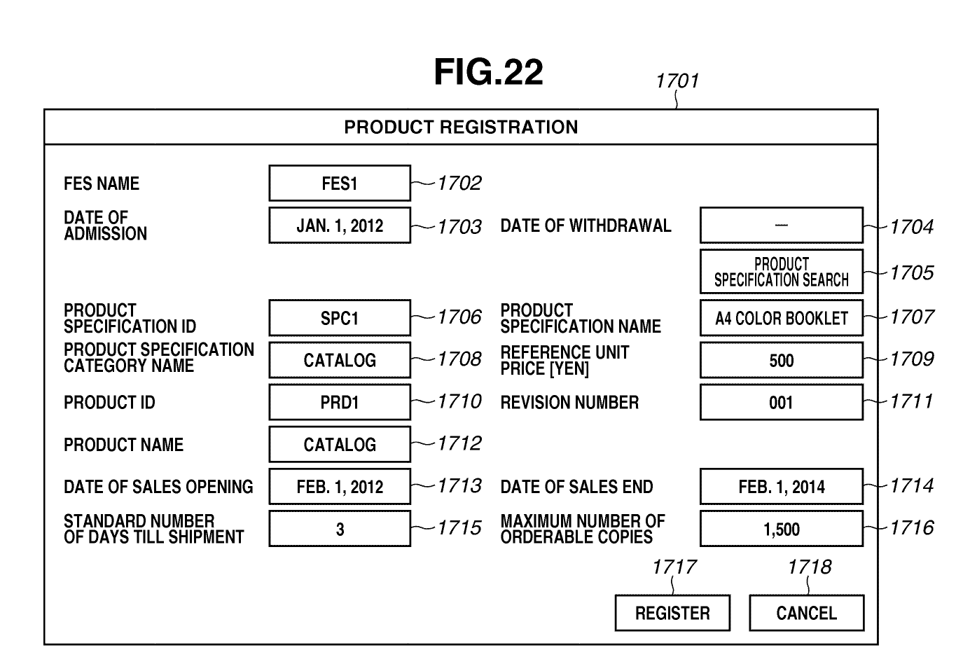

In step S209, the product management unit 315 receives information about a product input to a product registration screen illustrated in FIG. 22 displayed on the information display unit 329, and stores the information in the data storage unit 325.

FIG. 22 illustrates a register product screen 1701 for registering a product. A FES name 1702 indicates the name of an opening destination FES for the relevant product. A date of admission 1703 indicates the date when the printing company 3 joined to the FES denoted by the FES name 1702. A date of withdrawal 1704 indicates the date when the printing company 3 withdrew from the FES denoted by the FES name 1702. A product specification search button 1705 searches for a pre-registered product specification. Setting items includes a product specification ID 1706 of a product specification constituting the relevant product, a product specification name 1707, a product specification category name 1708, and a reference unit price 1709 of the product specification. A product ID 1710 is generated by the print order receiving and placing system when a new product is registered. A revision number 1711 manages the revision number of the product. A product name 1712 indicates the name of the product. Setting items include a date of sales opening 1713, a date of sales end 1714, a standard number of days till shipment 1715 indicating the standard number of days required till shipment, and a maximum number of orderable volumes 1716. A registration button 1717 accepts an operator's instruction for registering the relevant product with the above-described input setting items, and registers the current setting items in the data storage unit 325. A cancel button 1718 accepts an operator's instruction for canceling the product registration.

When a FES name is input in the FES name 1702, the product management unit 315 sets the date of admission when the printing company 3 joined the FES and, if the printing company 3 has withdrawn from the FES, the date of withdrawal, and updates the screen. The date of admission and the date of withdrawal are assumed to have been pre-registered in the print order receiving and placing system. When the operator sets the product specification ID 1706 in the register product screen 1701, the product and the product specification are associated with each other. Upon reception of the depression of the product specification search button 1705 from the operator, the product management unit 315 displays the product specification search screen 1401 illustrated in FIG. 18, receives a selected product specification from the operator, sets the setting items 1706 to 1709 corresponding to the relevant product specification in the product registration screen 1701, and updates the screen. As described above, a product is formed by appending necessary information, such as a date of sales starting and the standard number of days till shipment, to the product specification.

### <Registering an Item>

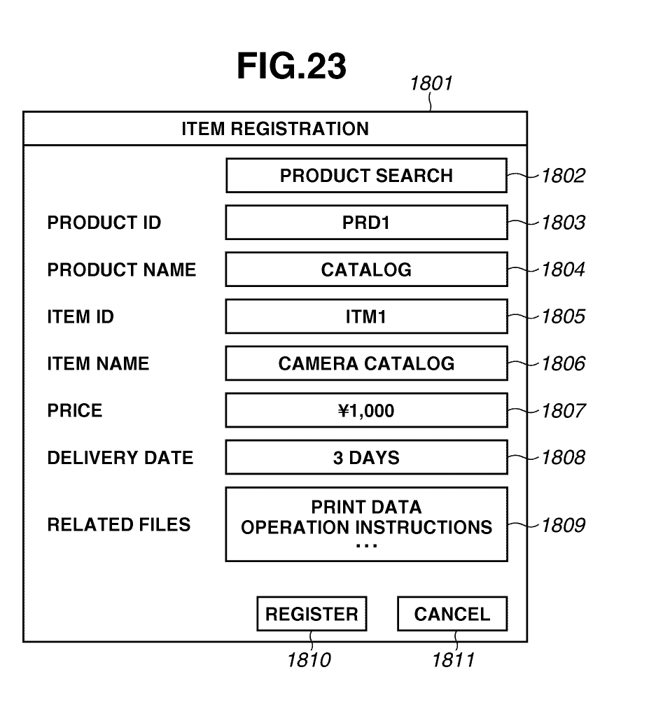

In step S210, the item management unit 316 receives information about an item input in an item registration screen illustrated in FIG. 23 displayed on the information display unit 329, and stores the information in the data storage unit 325.

FIG. 23 illustrates an item registration screen 1801 for registering an item. A product search button 1802 searches for a pre-registered product. Setting items related to the product include a product ID 1803, a product name 1804, an item ID 1805 generated by the print order receiving and placing system when a new item is registered, an item name 1806, a price 1807, and a delivery date 1808 of the relevant item. A related file registration field 1809 registers files related to the relevant item, such as print data and operation instructions. A registration button 1810 accepts an operator's instruction for registering the relevant item with the above-described input setting items, and registers the current setting items in the data storage unit 325. A cancel button 1811 accepts an operator's instruction for canceling the item registration. Upon reception of the press of the product search button 1802 from the operator, the item management unit 316 displays the product search screen (not illustrated). The product search screen displays predetermined narrow-down conditions, as with the product specification search screen 1401. Upon reception of a narrow-down condition input from the operator, the product search screen displays the search result, i.e., extracted products which satisfy the narrow-down conditions, in list form. When the operator selects a target product from the list of the search result, the item management unit 316 receives the selection, and closes the product search screen. The item management unit 316 acquires setting items for the selected product, including a product ID, a product name, a reference price, and the standard number of days till shipment, and displays the setting items as the product ID 1803, the product name 1804, the price 1807, and the delivery date 1808, respectively, in the item registration screen 1801. The operator can freely change the price 1807 and the delivery date 1808, referring to the reference price and the number of days till shipment. Thus, if the price and the delivery date of the item can be changed based on the reference price and the number of days till shipment of the product, the printing company 3 is able to change the price of the item according to the characteristics of the opening destination FES. With the above-described processing, the printing company 3 completes preparation for receiving an order.

### <Order Placement Processing by Purchaser>

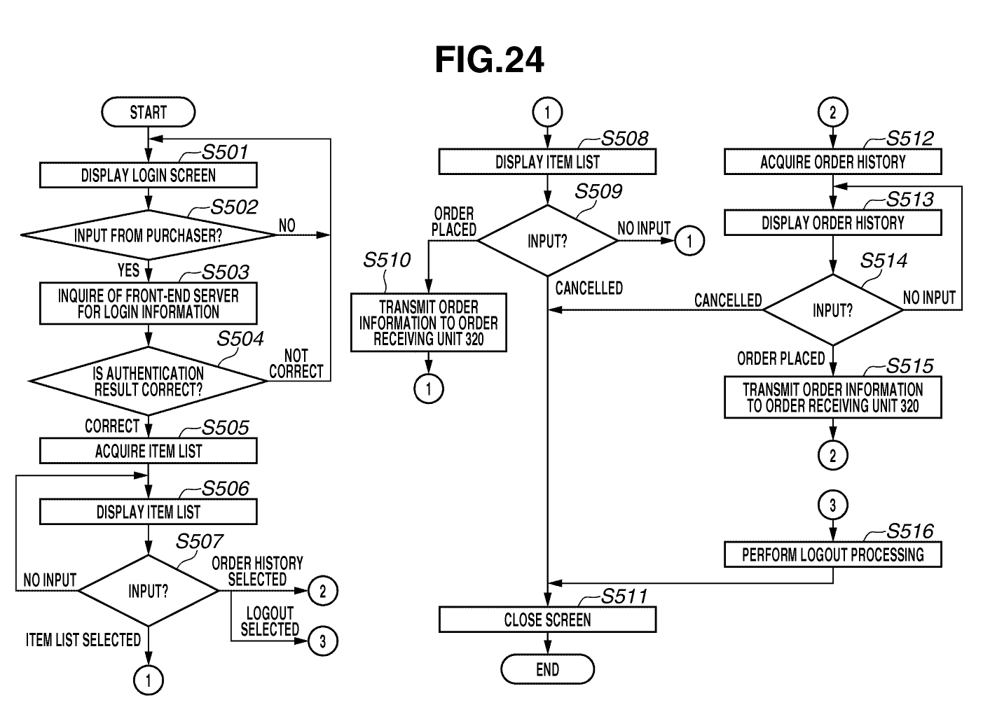

The following describes processing performed when the purchaser places an order for a print product, with reference to FIGS. 24 to 26.

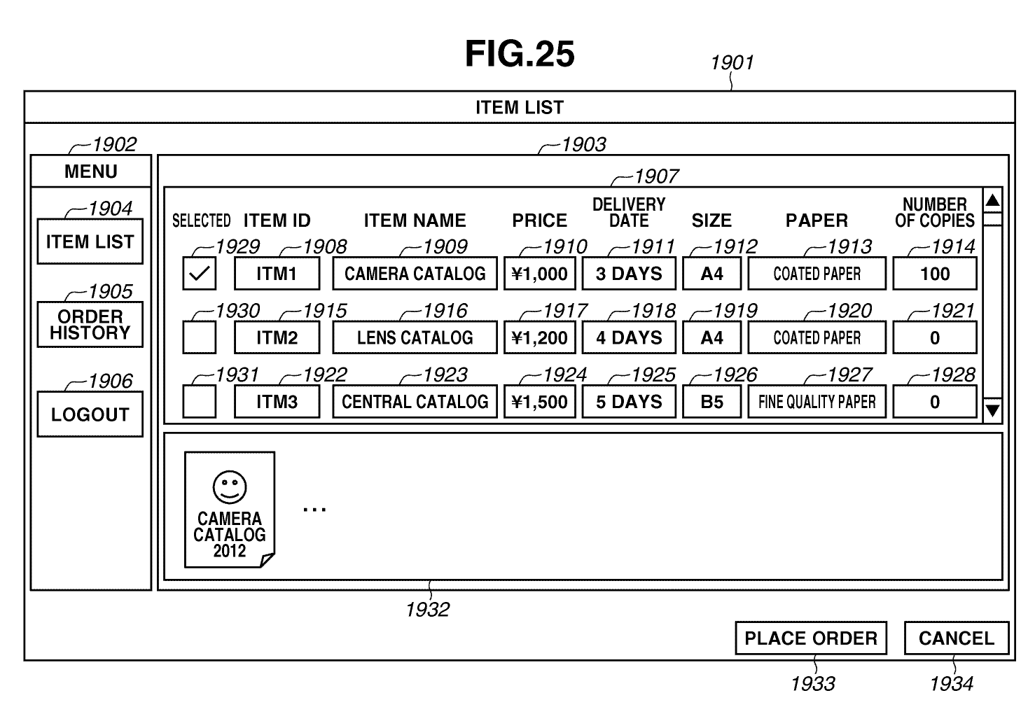

FIG. 24 is a flowchart illustrating processing in an order placing screen displayed on a purchaser's display. In step S501, the order information input unit 304 displays a login screen (not illustrated) on the purchaser's display. The login screen is provided with a login ID entry field and a login password entry field, and a login button for making an attempt of login based on the settings in the above-described entry fields. The purchaser enters in advance in the login ID entry field and the login password entry field a login ID and a login password, respectively, issued from the print order receiving and placing system. In step S502, the order information input unit 304 waits until the purchaser presses the login button. When the login button has been pressed (YES in step S502), the processing proceeds to step S503. On the other hand, when the login button has not been pressed (NO in step S502), the processing returns to step S501. In step S503, the order information input unit 304 transmits to the customer management unit 307 login information including the login ID and the login password entered in the login ID entry field and the login password entry field, respectively, to request authentication of the input information. In step S504, the order information input unit 304 acquires the result of the authentication from the customer management unit 307, and determines whether the result of the authentication is correct. When the result is correct (“CORRECT” in step S504), the processing proceeds to step S505. On the other hand, when the result is not correct (“NOT CORRECT” in step S504), the processing returns to step S501. In step S505, the order information input unit 304 acquires an item list from the item management unit 316. In step S506, the order information input unit 304 generates an item list screen as illustrated in FIG. 25 by using the above-described item list, and displays the item list on the purchaser's display.

FIG. 25 illustrates an item list screen 1901 for displaying an item list and a menu. A menu 1902 changes the screen. An item list preview 1903 displays a list of items orderable by the purchaser, and a preview of an item selected by the purchaser. Setting items include an item list button 1904, an order history button 1905, and a logout button 1906 for calling an item list screen, an order history screen, and a logout screen, respectively. An item list 1907 displays a list of items orderable by the purchaser. Setting items 1908 to 1928 are item information which includes setting items 1908 to 1914 for the first item, setting items 1915 to 1921 for the second item, and setting items 1922 to 1928 for the third item. Check boxes 1929, 1930, and 1931 select the first, the second, and the third items, respectively. A preview screen 1932 displays a preview of an item selected from the item list 1907 by the purchaser. An order place button 1933 accepts an operator's instruction for placing an order for the relevant item with the above-described input setting items, and transmits the current setting items to the order receiving unit 322. A cancel button 1934 accepts an operator's instruction for canceling the order placing procedures on the item list screen 1901. This button is not intended to cancel an order which has already been placed. The purchaser checks the check boxes 1929, 1930, and 1931 for items to be ordered out of the items displayed in the item list 1907, and then inputs the number of copies in the corresponding number-of-copies entry fields 1914, 1921, and 1928. FIG. 25 illustrates an example of an order placement for 100 copies of the first item.

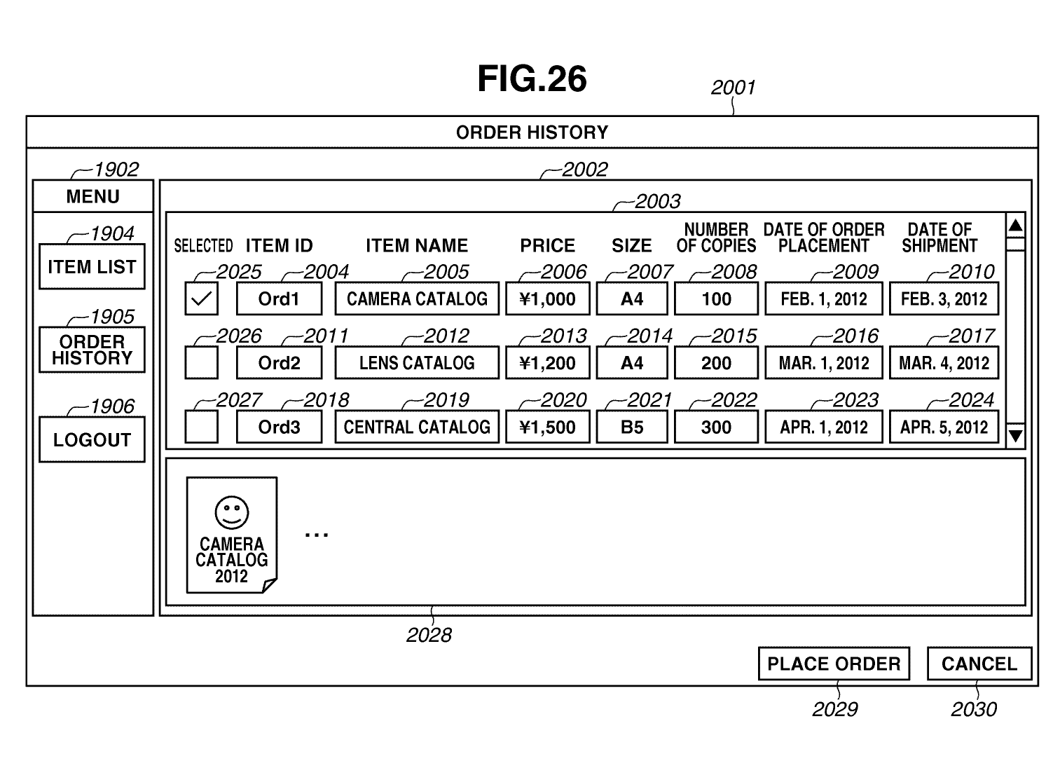

In step S507, the order information input unit 304 waits for an input from the purchaser. When the item list button 1904 has been pressed (“ITEM LIST SELECTED” in step S507), the processing proceeds to step S508. When the order history button 1905 has been pressed (“ORDER HISTORY SELECTED” in step S507), the processing proceeds to step S512. When the logout button 1906 has been pressed (“LOGOUT SELECTED” in step S507), the processing proceeds to step S516. When no input is received (“NO INPUT” in step S507), the processing returns to step S506. In step S508, the order information input unit 304 displays the item list screen 1901 if the item list screen 1901 is not displayed. In step S509, the order information input unit 304 waits for an input from the purchaser. When the order place button 1933 has been pressed (“ORDER PLACED” in step S509), the processing proceeds to step S510. When the cancel button 1934 has been pressed (“CANCELLED” in step S509), the processing proceeds to step S511. When no input is received (“NO INPUT” in step S509), the processing returns to step S508. In step S510, the order placing unit 305 transmits the order information to the order receiving unit 322. In step S511, the order information input unit 304 closes the item list screen 1901, and ends the processing. In step S512, the order information input unit 304 acquires an order history from the order management unit 317. In step S513, the order information input unit 304 displays on the purchaser's display an order history screen as illustrated in FIG. 26 by using the acquired order history.

FIG. 26 illustrates an order history screen 2001 for displaying the order history of the purchaser and a menu. An order list preview 2002 displays an order history list and a preview of an item selected by the purchaser. An order history list 2003 displays the order history in list form. Setting items 2004 to 2017 are order history information indicating the history of each order. Setting items 2004 to 2010 are order history information regarding the history of the first order. Setting items 2011 to 2017 are order history information regarding the history of the second order. Setting items 2018 to 2024 are order history information regarding the history of the third order. A preview screen 2028 displays a preview of an order history selected in the order history list 2003 by the purchaser. An order place button 2029 accepts an operator's instruction for placing an order for the relevant item with the above-described input setting items, and transmits the current setting items to the order receiving unit 322. A cancel button 2030 accepts an operator's instruction for canceling the order placing procedures on the order history screen 2001. This button is not intended to cancel an order which has already been placed. Referring to FIG. 26, setting items having the same function are assigned the same reference numeral, and description thereof will be omitted. In step S514, the order information input unit 304 waits for an input from the purchaser. When the order place button 2029 has been pressed (“ORDER PLACED” in step S514), the processing proceeds to step S515. When the cancel button 2030 has been pressed (“CANCELED” in step S514), the processing proceeds to step S511. When no input is received (“NO INPUT” in step S514), the processing returns to step S513. In step S515, the order placing unit 305 transmits the order information to the order receiving unit 322. In step S516, the order information input unit 304 cancels the connecting state of the relevant account ID, and allows the relevant account ID to log out. Through the above-described processing, the purchaser completes order placement.

### <Order Receiving Processing by Operator of Printing Company>

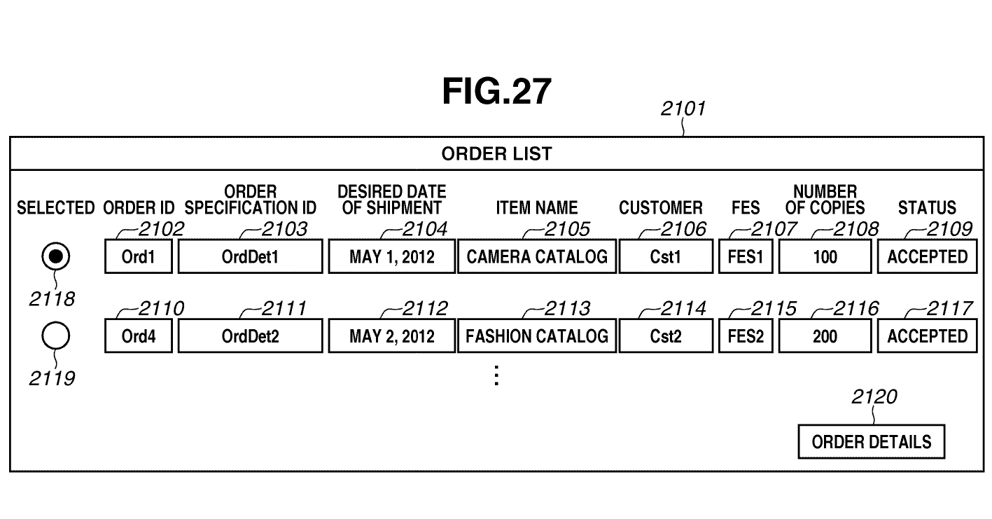

The following describes order receiving processing performed by the printing company 3 upon reception of an order, with reference to FIGS. 27 to 29.

FIG. 27 illustrates an order list screen. More specifically, FIG. 27 illustrates an order list screen 2101 for displaying a list of orders placed on the printing company 3 from the purchaser. Setting items 2102 to 2117 are a list of orders received by the printing company 3. The setting items 2102 to 2109 are setting items for the first order, and the setting items 2110 to 2117 are setting items for the second order (an order ID, an order specification ID, a desired date of shipment, an item name, a customer, an opening destination FES, the number of volumes, and a status indicating the progress of the relevant order). Radio buttons 2118 and 2119 are used to exclusively select the first order or the second order, respectively. An order details button 2120 calls a detailed order screen displaying detailed information about the selected order.

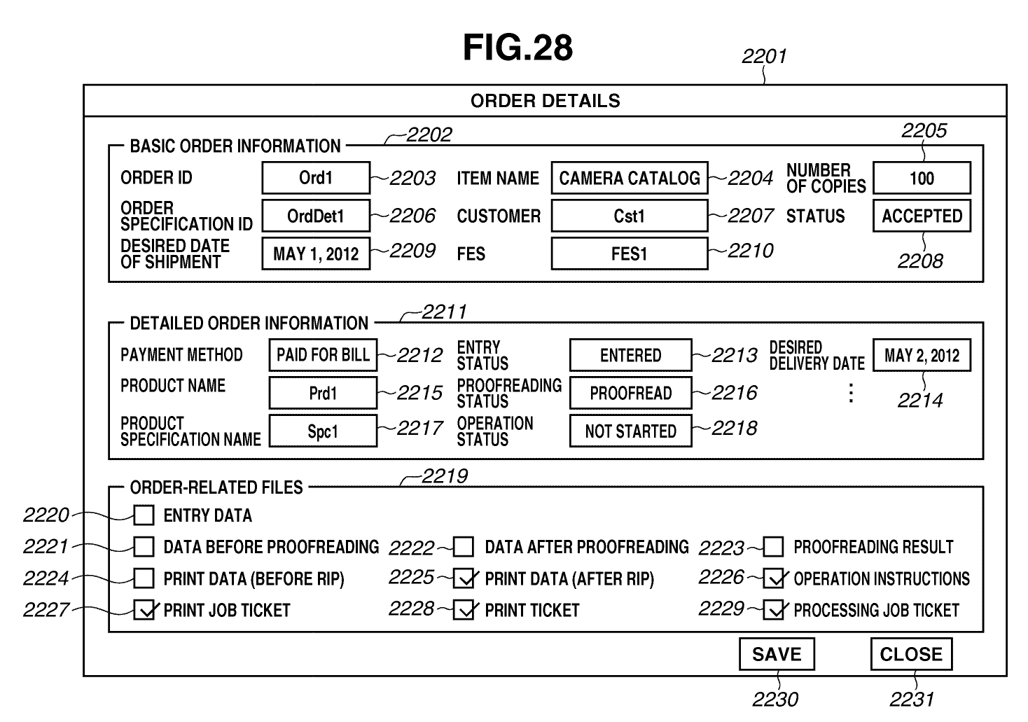

The following describes order receiving processing by the operator of the printing company 3. When the instruction input unit 327 receives an order list screen display request from the operator, the information processing unit 328 transmits the relevant request to the order management unit 317. The order management unit 317 extracts orders for the printing company 3 from the order information stored in the data storage unit 325, generates an order list, and transmits the order list to the information processing unit 328. Upon reception of the relevant order list, the information processing unit 328 displays the order list screen 2101 illustrated in FIG. 27 on the information display unit 329. When the operator selects an order and then presses the order details button 2120, the instruction input unit 327 receives a relevant input. Then, the information processing unit 328 transmits a detailed information transmission request for the selected order to the order management unit 317. The order management unit 317 extracts detailed information about the relevant order from the data storage unit 325, and transmits the information to the information processing unit 328. Upon reception of the relevant detailed information, the information processing unit 328 displays an order details screen illustrated in FIG. 28.

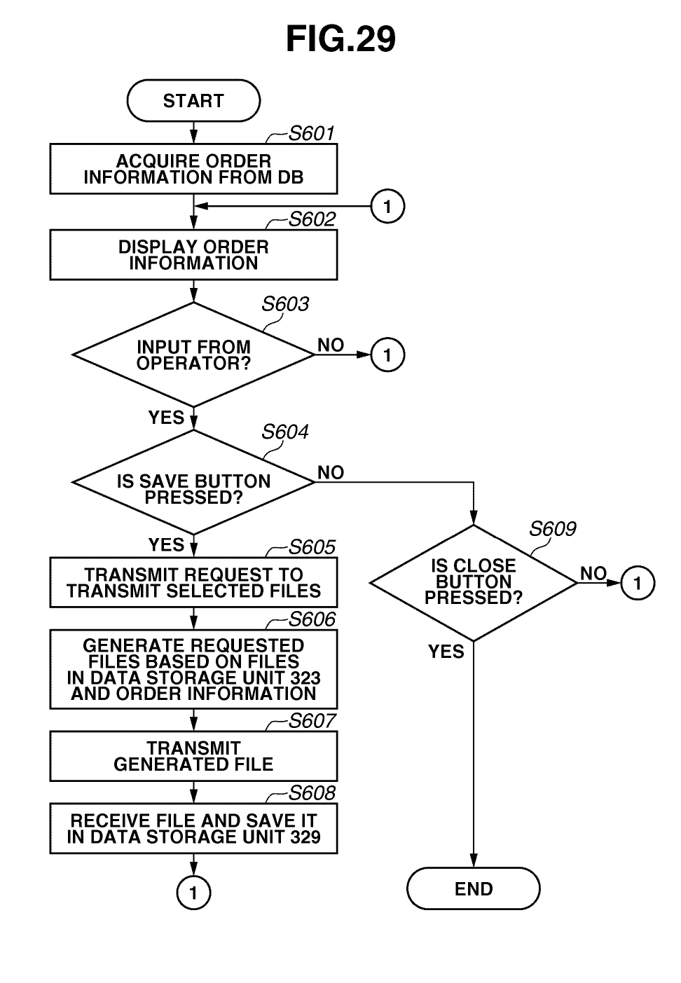

FIG. 28 illustrates an order details screen 2201 for displaying detailed information about an order selected in the above-described order list screen 2101. A basic order information display field 2202 displays basic information of the order. The basic order information includes an order ID 2203, an item name 2204, the number of copies 2204, an order specification ID 2205, a customer 2206, a status 2207, a desired date of shipment 2209, and an opening destination FES 2210. A detailed order information display field 2211 displays detailed information about the order. The detailed order information includes a payment method 2212, an entry status 2213, a desired delivery date 2214, a product name 2215, a proofreading status 2216, a product specification name 2217, and an operation status 2218. An order-related files display field 2219 displays files related to the order. The order-related files display field 2219 includes check boxes for selecting files to be acquired by the operator out of files related to the order: entry data 2220, data before proofreading 2221, data after proofreading 2222, a proofreading result 2223, print data (before raster image processing (RIP)) 2224, print data (after RIP) 2225, operation instructions 2226, a print job ticket 2227, a print ticket 2228, and a processing job ticket 2229. A save button 2230 acquires the selection state of each check box of the order-related files field 2220, and transmits a transmission request for checked files to the order management unit 317. A close button 2231 closes the order details screen 2201. The following describes processing performed when the order details button 2120 is pressed, with reference to FIG. 29. FIG. 29 illustrates processing in the order details screen 2201. In step S601, the order management unit 317 acquires detailed information about an order from the data storage unit 325, and transmits a script and an image for drawing the order details screen 2201 to the information processing unit 328. In step S602, the information processing unit 328 displays the acquired script and image on the information display unit 329. In step S603, the information processing unit 328 waits for an input from the operator. When an input has been received (YES in step S603), the processing proceeds to step S604. On the other hand, when no input has been received (NO in step S603), the processing returns to step S602. In step S604, the information processing unit 328 determines whether the save button 2230 has been pressed. When the save button 2230 has been pressed (YES in step S604), the processing proceeds to step S605. On the other hand, when the save button 2230 has not been pressed (NO in step S604), the processing proceeds to step S609. In step S605, the information processing unit 328 acquires the selection state of each check box of the order-related files field 2220, and transmits a transmission request for checked files to the order management unit 317. In step S606, the generation unit 323 extracts relevant files from the data storage unit 325, and generates files based on the files and order information. In step S607, the output unit 324 transmits the generated files to the information processing unit 328. In step S608, the information processing unit 328 receives the files and stores them in the data storage unit 330. In step S609, the information processing unit 328 determines whether the close button 2231 has been pressed. When the close button 2231 has been pressed (YES in step S609), the processing ends. On the other hand, when the close button 2231 has not been pressed (NO in step S609), the processing returns to step S602.

Through the above-described processing, the operator is able to acquire information required for printing and processing. Then, when the operator enters print data in HotFolder based on these pieces of information, the printing unit 331 prints a print product. Then, when the operator enters a processing job ticket in the processing machine, the processing unit 332 processes the printed print product. This completes the production of a print product.

The above-described techniques enable generating a product specification by using a preset print setting, a preset print process, and a preset processing process, and further generating a product by using the product specification, thus reducing the number of operation processes for generating a print product. Further, even when registering a new product specification to generate a new product based on pre-registered information, it is possible to reduce the number of input items and input errors accompanying input operations.

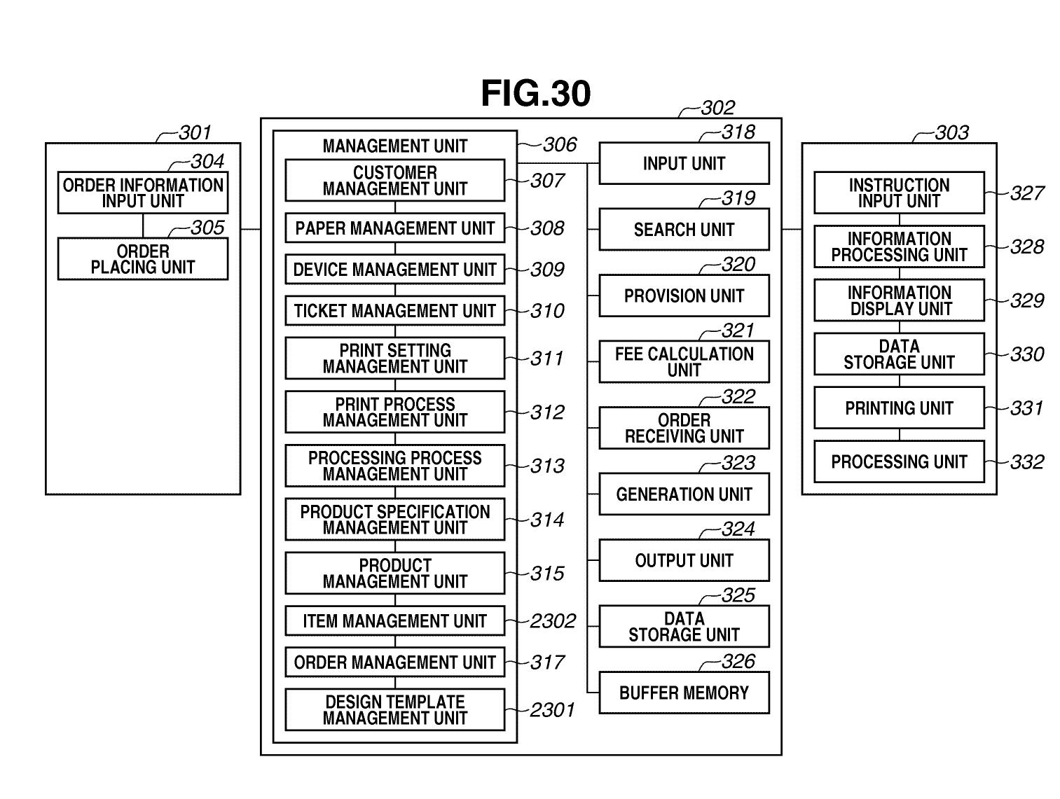

In the first exemplary embodiment, the purchaser and the printing company 3 adjust a print specification, the operator of the printing company 3 registers an item based on a determined print specification, and the purchaser browses the registered item and places an order. This processing flow for placing an order has been often performed when the purchaser of the printing company 3 is a regular customer. A second exemplary embodiment, on the other hand, is based on a case where design templates of print data are disclosed on a web site, and a large indefinite number of purchasers access the web site, edit design, and enter data, as is the case with Web-to-Print services developed in recent years. A hardware configuration of the present exemplary embodiment is similar to that of the first exemplary embodiment, and redundant description thereof will be omitted. FIG. 30 illustrates a logical configuration according to the present exemplary embodiment. Referring to FIG. 30, a design template management unit 2301 manages design templates pre-designed according to predetermined purposes, such as a business card and a New Year's card. An item management unit 2302 associates an item with a related design template.

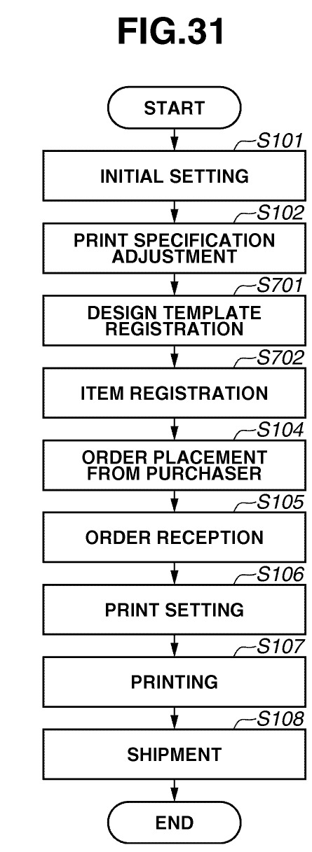

The following describes an overall processing flow of printing according to the present exemplary embodiment, with reference to FIG. 31. FIG. 31 describes the overall processing flow of printing. In step S701, the operator of the printing company 3 registers in the print order receiving and placing system a design template designed by using a design editing application. In step S702, in addition to the processing in step S103, the operator of the printing company 3 associates the design template with an item.

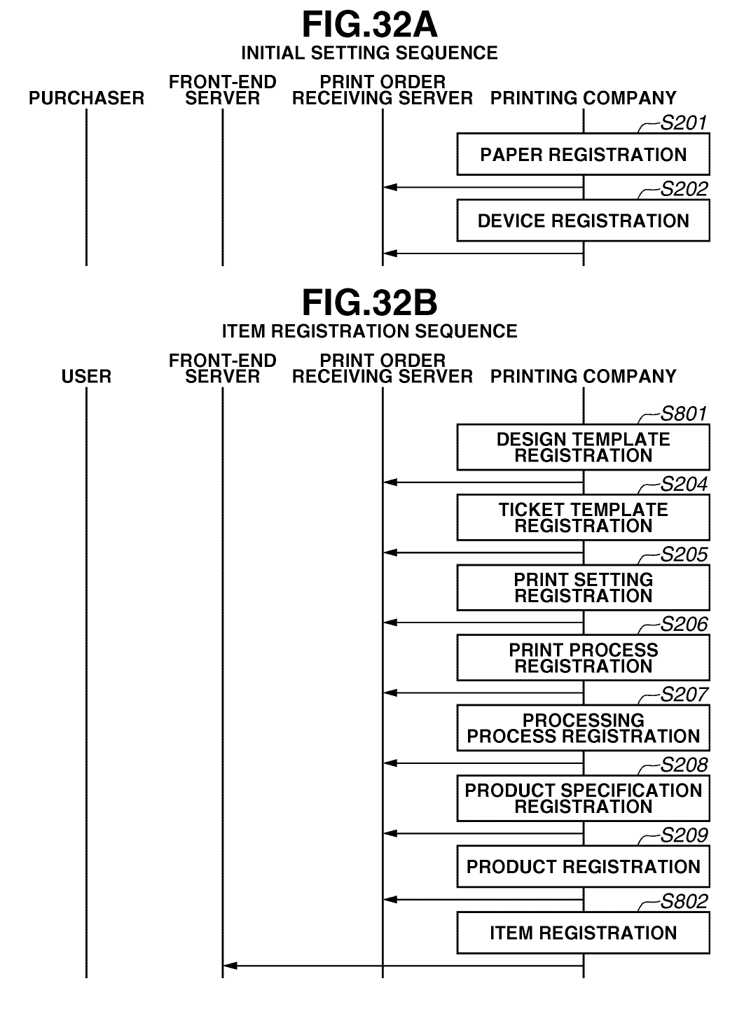

FIGS. 32A and 32B are sequence charts illustrating initial setting and item registration, respectively. In step S801, the design template management unit 2301 receives a design template edited via the instruction input unit 327, and stores the design template in the data storage unit 325. In step S802, the item management unit 316 associates an item with a related design template, and stores the design template in the data storage unit 325.

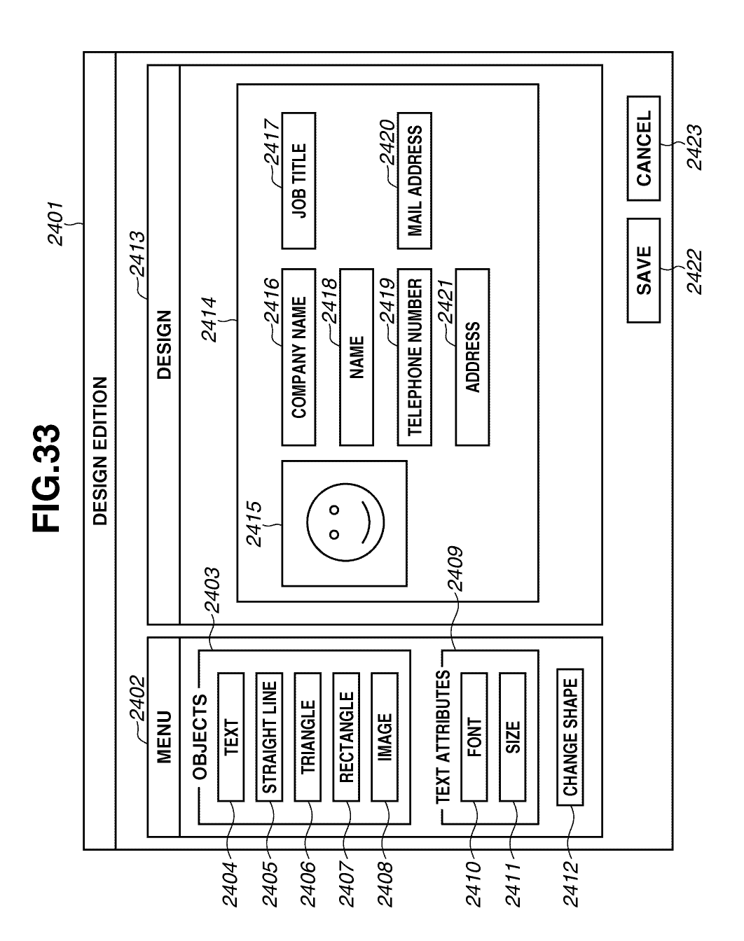

FIG. 33 illustrates a design editing screen to be used to edit a design template when the purchaser places an order for a business card. FIG. 33 illustrates a design edit screen 2401 for editing a design template. A menu 2402 collects buttons for changing object and text attributes in the design template. An objects group 2403 includes buttons for arranging a text and graphics in the design template: a text button 2404, a straight line button 2405, a triangle button 2406, a rectangle button 2407, and an image button 2408. A text attributes group 2409 includes buttons for changing the attribute of a text object arranged in the design template: a font button 2410 for changing the font of a text object, and a size button for changing the size of a text object. A change shape button 2412 changes the shape of an object. A design campus 2413 is a field for editing the design template. The design campus 2413 displays objects 2414 to 2421 of the design template of a business card. A paper object 2414 indicates paper which includes an image object 2415 and text objects 2416 to 2421. The image object 2415 is used to arrange an image, such as a facial portrait of an owner of the business card and a logo mark of a company. The text objects 2416 to 2421 include a company name 2416, a job title 2417, a name 2418, a telephone number 2419, a mail address 2420, and an address 2421. A save button 2422 receives a purchaser's instruction for inputting data for the above-described design, and stores the result of design editing in the data storage unit 325. A cancel button 2423 accepts an operator's instruction for canceling editing operations made in the design edit screen 2401.

Thus, pre-registering an item and a design template in an associated way enables the operator to automatically acquire a print job ticket and operation instructions suitable for the design template. Accordingly, print data can be prevented from being input in a wrong way, thus reducing occurrence of mistakes.

According to the above-described exemplary embodiments, a product specification can be generated according to an ordered print specification by using a pre-registered product specification and a pre-registered print process. This enables generating a product specification for producing an ordered print product with a smaller number of processes. Thus, a printing company 3 is able to deliver a print product to the purchaser in a shorter delivery period. Further, since a new product specification and a new print process can be generated by using a pre-registered product specification and a pre-registered print process, the amount of input operations can be reduced. This enables preventing useless printing resulting from input errors, and preventing such mistakes as delivering a print product having different finish from ordered one.

Although, in the above-described exemplary embodiments, a print setting is a subordinate component of a print process, the configuration is not limited thereto. Information included in a print setting may be included in a print process. Although, in the above-described exemplary embodiments, all of information about processing is included in a processing process, the configuration is not limited thereto. A piece of information specific to each piece of processing may be separated as a processing setting, and information common to various processing processes may be included in a processing process.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory(RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-263128 filed Nov. 30, 2012, which is hereby incorporated by reference herein in its entirety.

What is claimed is:

1. A print order receiving and placing system for receiving a print product production request from an order placing terminal, the print order receiving and placing system comprising:
a print process registration unit configured to register a print process including setting information related to printing by a printing machine;
a processing process registration unit configured to register a processing process including setting information related to processing by a processing machine;
a product registration unit configured to register a product including a product specification defining a print process selected from a plurality of print processes registered by the print process registration unit, a processing process selected from a plurality of processing processes registered by the processing process registration unit, and order information regarding an execution order of these processes; and
an item registration unit configured to register the product registered by the product registration unit as an item which can be ordered from the order placing terminal.

2. The print order receiving and placing system according to claim 1, further comprising:
a product specification registration unit configured to register the product specification,
wherein the product registration unit specifies a product specification selected from a plurality of product specifications registered by the product specification registration unit, and registers a product.

3. The print order receiving and placing system according to claim 1, wherein the print order receiving and placing system displays a layout drawing for specifying an execution order of a plurality of processes by arranging a plurality of process parts and connecting the plurality of process parts, and accepts a specification of the execution order via the layout drawing.

4. The print order receiving and placing system according to claim 1, wherein the setting information related to printing includes at least one of:
identification information of the printing machine, a print side setting, a paper orientation setting, a print color setting, a paper size setting, and applicable paper.

5. The print order receiving and placing system according to claim 1, further comprising:
a search unit configured to search for each piece of information registered by the print process registration unit, the processing process registration unit, the product registration unit, and the item registration unit.

6. A control method for controlling a print order receiving and placing system for receiving a print product production request from an order placing terminal, the method comprising:
registering a print process including setting information related to printing by a printing machine;
registering a processing process including setting information related to processing by a processing machine;
registering a product including a product specification defining a print process selected from a plurality of print processes registered by the registering a print process, a processing process selected from a plurality of processing processes registered by the registering of a processing process, and order information regarding an execution order of these processes; and
registering the registered product, as an item which can be ordered from the order placing terminal.

7. A storage medium storing a program for causing a computer to execute the control method according to claim 6.
